(19) United States
(12) Patent Application Publication
(10) Pub. No.: US 2004/0090439 A1
(43) Pub. Date: May 13, 2004

(54) Recognition and interpretation of graphical and diagrammatic representations

(76) Inventor: Holger Dillner, Wolgast (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/292,416

(22) Filed: Nov. 7, 2002

(51) Int. Cl. G06F 9/44; G06T 11/20

(52) U.S. Cl. 345/440; 717/100

(57) ABSTRACT

A system and method for recognizing and interpreting diagrammatic and graphical representations in a computer. A user specifies a problem by inputting a graphical or diagrammatic representation of the problem. A recognition process according to the invention identifies symbols in the representation, identifies relationships between the symbols, and generates an adjacency matrix corresponding to a graph that represents information obtained from the identified symbols and their relationships to each other. The adjacency matrix may be simplified and used to produce computer-readable output for execution by other program components to solve the problem. With this invention, users can easily use their Tablet PCs, smart pens, other pen-centric computers or any other such input mechanisms (such as WACOM tablets or mouse) to “draw” their problem and solve it.

### FIELD OF THE INVENTION

The present invention relates to automated and semi-automated recognition and interpretation of graphical and diagrammatic representations in a computer.

### BACKGROUND OF THE INVENTION

Graphical and diagrammatic representations are widely used in engineering and mathematical fields to specify and solve problems. There exists a wide variety of visual languages, such as Pygmalion, GRAIN, PAGG, and PROGRES (Ehrig 1999); graphically-oriented development tools, such as LabVIEW™, AGILENT-VEE (formerly known as HP-VEE), and Simulink®; and graphical design schemes, such as UML, flowcharts, and state machines. To solve an engineering or mathematical problem using a computer today, the problem must be specified in a way that strictly adheres to the well-defined syntax and semantics of the software used to solve the problem. Only when a problem is properly specified according to the requirements of the underlying software environment does a syntactically and semantically correct solution result.

Nevertheless, versions of such tools that accept handwritten and hand drawn input encounter numerous problems that are virtually unknown in the more formalized field of computer-aided treatment. Handwritten and hand drawn representations require significant implicit knowledge and agreement about graphical layout for the correct meaning of the handwritten or hand drawn representations to be recognized and understood.

Specifying mathematical and engineering problems would be much easier to a user if the problem could be described in a way that is best known to the user, without being restricted by the particular interface of the software that the user wishes to use to solve the problem. This may be done by drawing schematics, writing equations, using images, writing text, etc. In other words, users typically find it easier to specify problems using graphical or diagrammatic representations of their own design. These representations are typically two dimensional in nature.

The prior art has encountered considerable difficulty in bridging the gap between user-drawn or user-provided graphical representations and the rigid input requirements of software and hardware tools available on the market. First, it has been difficult to input diagrammatic and graphical representations of problems directly into a computer. With the emerging class of pen-centric computers, smart pens, and scanners, this limitation is expected to diminish. Second, good algorithms that recognize and interpret diagrammatic and graphical representations of problems are lacking. Versions of graphically-oriented development tools that accept hand drawn or scanned input continue to encounter problems. Computer-based recognition of graphical or diagrammatic representations has been actively researched for many years. Yet, despite all these efforts, robust and efficient algorithms for recognizing and interpreting such representations remain unavailable.

The following description provides an example of prior work that has been done in this field. Hammond and Davis [2002] and Lank et al. [2000], for example, worked on recognition of hand drawn UML (Unified Modeling Language) diagrams. Ideogramic UML™ is a commercially available gesture-based diagramming tool from Ideogramic and allows users to sketch UML diagrams (Damm [2000]).

Other papers have dealt with general sketch recognition (for example, Landay and Mayers [1995], Bimber et al. [2000], Forbus et al. [2000], Alvarado [2002], Ferguson and Forbus [2002]). This field is still in its infancy and there is no generally accepted approach to solving sketch recognition problems. Because of the very nature of sketches, more formalized tools such as grammars, parsers and graph rewriting systems are conventionally seen to be too specific to handle a broad class of sketch recognition problems.

Papers such as Chang [1970], Anderson [1977], Wang and Faure [1988]), Miller and Viola [1998], Smithies et al. [1999], Matsakis [1999], and Zanibbi [2000], have been published on the subject of handwritten formula recognition. Chan and Yeung [1999] and Blostein and Grbavec [1997] published survey papers that described the state-of-theart in handwritten formula recognition. Some experimental systems such as Zanibbi's “The Freehand Formula Entry System (FFES)” have been proposed. FFES is an interpretive interface for entering mathematical notation using a mouse or data tablet. However, no commercial systems are available as of today.

Pagallo [1994] (U.S. Pat. No. 5,317,647 “Constrained attribute grammars for syntactic pattern recognition”) describes a method for defining and identifying valid patterns for use in a pattern recognition system. The method is suited for defining and recognizing patterns comprised of subpatterns that have multi-dimensional relationships. Pagallo [1996/1997] (U.S. Pat. Nos. 5,544,262 and 5,627,914 “Method and apparatus for processing graphically input equations”) also describes a method for processing equations in a graphical computer system.

Matsubayashi [1996] (U.S. Pat. No. 5,481,626 “Numerical expression recognizing apparatus”) describes an apparatus for recognizing a handwritten numerical expression and outputting it as a code train. The pattern of the numerical expression is displayed by a liquid crystal display. Morgan [1997] (U.S. Pat. No. 5,655,136 “Method and apparatus for recognizing and performing handwritten calculations”) describes a pen-based calculator that recognizes handwritten input.

Query processing in sketch-based databases applications can be found in Gross and Do [1995] and Egenhofer [1997]. Gross and Do examined the relation between architectural concepts and diagrams. Egenhofer's Spatial-Query-by-Sketch is a sketch-based GIS user interface that focuses on specifying spatial relations by drawing them.

Bobrow [2002] (U.S. Patent Application Publication No. 20020029232 “System for sorting document images by shape comparisons among corresponding layout components”) segments document images into one or more layout objects. Each layout object identifies a structural element in a document such as text blocks, graphics, or halftones. The system then sorts the set of image segments into meaningful groupings of objects which have similarities and/or recurring patterns.

Lecolinet [1998] proposes an approach based on visual programming and constrained sketch drawing. At the early stages of the iterative conception process, Guls are interactively designed by drawing a “rough sketch” that acts as a first draft of the final description. This drawing is interpreted in real time by the system in order to produce a corresponding widget view (the actual visible GUI) and a graph of abstract objects that represents the GUI structure.

Boyer et al. [1992] (U.S. Pat. No. 5,157,736 “Apparatus and method for optical recognition of chemical graphics”) describe an apparatus and method that allows documents containing chemical structures to be optically scanned so that both the text and the chemical structures are recognized. Kurtoglu and Stahovich [2002] describe a program that takes freehand sketches of physical devices as input, recognizes the symbols and uses reasoning to understand the meaning of the sketch.

Embodiments of the invention presented herein are directed to recognition and interpretation of graphical and diagrammatic representations in a computer. The invention is based, in part, on a recognition scheme that can be easily generalized to cases where recognition of diagrams and graphically-oriented constructs, such as visual programming languages, is required. These constructs include formulas, flowcharts, graphical depictions of control processes, stateflow diagrams, graphics used for image analysis, etc. The present invention provides more robust algorithms for recognition and interpretation of graphical and diagrammatic input than is presently known in the prior art.

### SUMMARY OF THE INVENTION

The recognition scheme provided herein can be applied to the recognition and interpretation of problems specified using graphical and diagrammatic representations. In one aspect, the scheme presented herein provides a way of recognizing implicit knowledge in a graphical or diagrammatic representation. Where necessary and desired, the scheme also represents and resolves ambiguities that arise in while recognizing the graphical or diagrammatic representations. The result is an internal representation in the form of an adjacency matrix corresponding to a graph that may be interpreted, executed, transformed, reduced, or otherwise processed by other software tools.

The recognition scheme presented herein realizes the following:

A. It identifies graphical and/or diagrammatic objects, or symbols, and relationships between them (including hierarchical and nested relationships), and translates the syntactical structure of the given graphical or diagrammatic representation into an intermediate representation in the form of a graph or hypergraph. The nodes of the graph or hypergraph represent the graphical and/or diagrammatic objects or relationships between them. The edges and/or hyperedges in the graph connect the nodes and may be augmented with semantic meaning. The nodes and edges are arranged to represent information obtained from the identified symbols and their relationship to each other.

B. It reduces the intermediate graph and/or hypergraph using one or more rules that are preferably applied until the graph and/or hypergraph is resolved. The rule(s) are applied to the adjacency matrix to modify the nodes and edges in the corresponding graph toward a desired arrangement. The final arrangement of this reduction procedure could be exactly one node (e.g. a computer-readable expression that represents the original problem) or a graph and/or hypergraph that can be executed or interpreted by a software tool.

C. It may also manipulate the graph and/or hypergraph and generate a (generalized) minimum spanning tree or a minimum spanning graph, if necessary or desired. In some circumstances, the construction of a (generalized) minimum spanning tree may be omitted depending on the end goal of the recognition process. In either case, the simplification and manipulation of the graph is based on rules and/or sets of rules designed for the type of problem under consideration.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates one example of a problem specified using hand drawn input;

FIG. 2 illustrates an example of an adjacency matrix corresponding to a graph having one or more nodes in an arrangement;

FIG. 3 illustrates another example of hand drawn input and an overview of a process for recognition and interpretation of the hand drawn input;

FIG. 4 illustrates one example of a handwritten formula;

FIG. 5A depicts an initial graph of the formula in FIG. 4;

FIG. 5B is a simplified graph of the formula in FIG. 4 before applying a minimum spanning tree algorithm;

FIG. 6 is a minimum spanning tree representation of the formula in FIG. 4;

FIG. 7 provides an example of rules that may be applied to simplify an adjacency matrix of the formula in FIG. 4;

FIG. 8 provides an example of a rule that may be applied to resolve nodes in an adjacency matrix of the formula in FIG. 4;

FIG. 9 illustrates another example of a handwritten formula;

FIG. 10 is a simplified graph of the formula in FIG. 9 before applying a minimum spanning tree algorithm;

FIG. 11 is a minimum spanning tree representation of the formula in FIG. 9;

FIG. 12 illustrates components of an integral operation;

FIG. 13 illustrates components of an integral operation with bounds;

FIG. 14 illustrates components of a root operation;

FIG. 15 illustrates an example of a hand drawn Simulink® diagram;

FIG. 16 provides an example of rules that may be used to simplify an adjacency matrix of the diagram in FIG. 15;

FIG. 17 is a directed minimum spanning graph representation of the diagram in FIG. 15;

FIG. 18 depicts a reduced minimum spanning graph of diagram in FIG. 15;

FIG. 19 provides an example of rules that may be applied to an adjacency matrix corresponding to the graph in FIG. 17 to obtain the reduced graph in FIG. 18;

FIG. 20 illustrates a portion of Simulink® code derived from the graph in FIG. 18;

FIG. 21 depicts a Simulink diagram and output resulting from executing the code in FIG. 20;

FIGS. 22A and B provide a typical LabVIEW™ program with a front panel and corresponding diagram;

FIG. 23 illustrates a hand drawn example of the LabVIEW diagram in FIG. 22B;

FIG. 24 illustrates a hand drawn example of the LabVIEW front panel in FIG. 22A;

FIG. 25 illustrates an example set of icons that could be used as hand drawn LabVIEW VIs;

FIG. 26 illustrates a hand drawn version of an AGILENT-VEE diagram;

FIG. 27 depicts a resulting AGILENT-VEE diagram obtained after recognizing and interpreting the diagram in FIG. 26;

FIG. 28 provides standard elements of a flowchart;

FIG. 29 illustrates an example of a hand drawn flowchart;

FIG. 30 illustrates an example of a hand drawn stateflow diagram;

FIG. 31 illustrates a stateflow diagram obtained after recognizing and interpreting the diagram in FIG. 30;

FIG. 32 depicts visually distinct hand drawn graphical formulas that generate identical canonical tree representations;

FIG. 33 shows a generalized canonical tree representation of the formulas in FIG. 32;

FIG. 34 illustrates an example of recognizing an equation specified by a hand drawn marking in a visually presented image file;

FIG. 35 illustrates an example of a hand drawn filter design specification;

FIG. 36 depicts a hypergraph representation of the filter specification in FIG. 35;

FIG. 37 illustrates an example of a hand drawn control design specification;

FIG. 38 illustrates an example of a hand drawn sketch of a real world measurement and control system;

FIG. 39 illustrates an example of a visual image and hand drawn sketch that specifies a machine vision application;

FIG. 40 provides a flow diagram obtained from recognizing and interpreting the specification illustrated in FIG. 39; and

FIG. 41 provides another example of a hand drawn specification for a machine vision application that results in the flow diagram shown in FIG. 40.

### DETAILED DESCRIPTION OF THE PREFERRED EMBODIMENT

A graph is a mathematical object comprised of one or more nodes. Edges in a graph are used to connect subsets of the nodes. The term “graph” in this context is not to be confused with “graph” as used in analytic geometry. Where the relationship between nodes in a graph is symmetric, the graph is said to be undirected; otherwise, the graph is directed.

A generalization of a graph is called a hypergraph. Where simple graphs are two dimensional in nature and easily depicted on paper, hypergraphs are abstract objects that are typically multidimensional in nature and are not easily illustrated. For instance, in a hypergraph, a hyperedge may simultaneously connect three or more nodes.

As used herein, the term “graph” includes both graphs and hypergraphs. Similarly, the term “edge,” as used herein, includes both edges and hyperedges. For ease of description only and not to limit the invention in any manner, the disclosure herein uses the terms “graph” and “graphs,” as well as “edge” and “edges,” in this broad inclusive manner. Also, the term “recognition” herein may include both recognition and interpretation of graphical and diagrammatic objects and their relationship to one another.

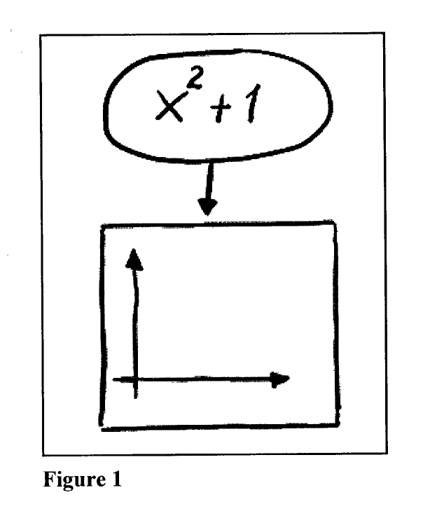

FIG. 1 illustrates one example of a handwritten problem. As shown, the handwritten problem requires significant implicit knowledge and agreement about graphical layout to represent the correct meaning of the drawing. A recognition process according to the present invention is able to encode such implicit knowledge and agreement in the form of a graph. Further, ambiguities presented by handwritten or hand drawn material, including text, formulas and diagrams, can be resolved. For example, many users would intuitively read the problem specified in FIG. 1 as requesting the computer to draw an X-Y axis with a line depicting solutions to the formula y=x²+1. A recognition process according to the invention would generate a graph that, with ambiguities resolved, may be executed by a program in the computer to draw the solution on an X-Y axis.

In one aspect, an embodiment of the invention uses one or more rules to manipulate and interpret graphical symbols recognized in a drawing and construct a graph representing the problem in the drawing. In another aspect, an embodiment of the invention encodes ambiguities as additional nodes, edges, and/or properties in the graph. Additional discussion regarding graph construction, simplification, and resolution is provided below.

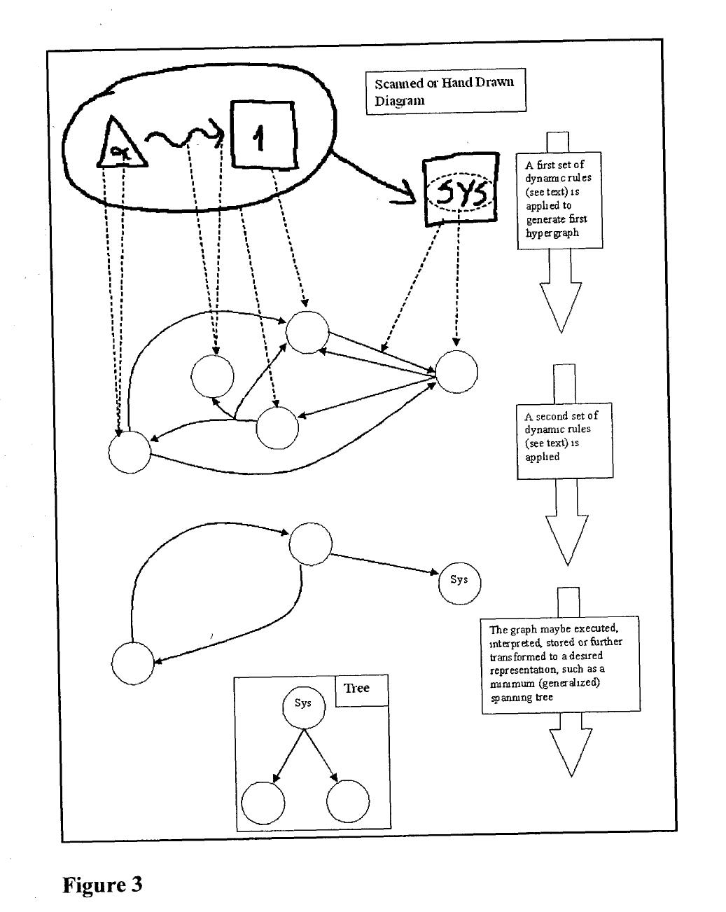

FIG. 3 illustrates another example of hand drawn input and an overview of a process according to the invention that is used to recognize and interpret the hand drawn input. The recognition process performed in this example is comprised of the following characteristics:

1. The original hand drawn or handwritten diagram contains identifiable graphical objects, or symbols. Symbols can be formed of groupings of strokes, individual strokes, or even parts of a stroke. As to the latter, heuristics may be used to distinguish parts of a stroke, such as breaking strokes at sharp corners.

Identification of hand drawn symbols can be performed by a variety of known methods, including, for example, pixel-oriented matching using normalized cross-correlation; shape-based or geometric-based matching; use of color information; methods based on curvature of strokes; graph theory (e.g., based on adjacency of separate strokes); and neural networks, to name a few. Details of suitable methods using these techniques are well-known to those having ordinary skill in the art. See, e.g., Chan, K.-F., Yeung, D.-Y., Mathematical expression recognition, Technical Report HKUST-CS99-04, 1999; Chou, P. A., Recognition of equations using a two-dimensional stochastic context-free grammar, Proceedings SPIE Visual Communications and Image Processing IV, 1192:852-863, November 1989; and Blostein, D., Grbavec, A., Recognition of mathematical notation, chapter 22. World Scientific Publishing Company, 1996. In some circumstances, where suitable, curves may be used to replace handwritten strokes. A curve is a collection of neighboring points. A grouping of curves can be used as a substitute for a grouping of strokes. A portion or all of the symbols in the original graphical or diagrammatic representation may be identified in this aspect of the recognition process.

2. Some or all of the identified symbols and their relationship to each other are translated into an arrangement of nodes, edges, properties of nodes and properties of edges in a graph. The translation is performed by applying a first set of static rules, dynamic rules, and/or heuristics to generate the nodes, edges, and properties of a graph. The resulting graph is stored in computer memory in the form of an adjacency matrix for further processing. Ambiguities, such as those resulting from the symbol recognition process and from determining relationships between the symbols, are incorporated into this initial intermediate graph. One approach to incorporating ambiguities is to add redundant nodes or edges to the graph. Another approach is to add specific rules to the process that handles ambiguities as they arise so that the graph is modified appropriately when the rules are executed.

3. A second set of static rules, dynamic rules, and/or heuristics is applied to transform the graph into a reduced graph. A reduced graph is intended to eliminate ambiguities of the problem that are present in the initial graph, as well as resolve redundant or unnecessary information.

4. Rules or sets of rules can be applied repeatedly to the graph to transform the graph toward a desired arrangement, or desired representation. A desired arrangement may be, for example, a simple directed graph with semantics assigned to edges. This arrangement is particularly advantageous, for example, for specifying pen-based simulations. The intermediate step of applying rules to graphs can be repeated as often as necessary, with possibly many different rules and/or sets of rules.

5. If required, the final graph can be further transformed to an alternative representation using an algorithm that results in such representation. For example, a generalized minimum spanning tree algorithm may be applied to a graph that represents a formula. The resulting tree uniquely specifies the formula and can be used to compute values according to the formula. Another example is to apply a standard spanning tree algorithm to a directed graph that represents a hand drawn pen simulation diagram. For instance, an intermediate graph for a Simulink® diagram may be transformed to a text file that specifies the Simulink diagram and is understood by the Simulink program. Such transformation is performed using rules defined for the particular task. Further detail regarding such a transformation is provided later herein.

Recognition of hand drawn input, such as shown in FIG. 3, can be further understood by observing the following:

1. A recognition process can be performed offline, for example, after a drawing has been scanned into a computer from printed drawings (produced by hand or by machine) or after a formula or diagram has been drawn by the user. A recognition process can also be performed online (i.e., on-the-fly) while a formula or diagram is being drawn by the user.

2. Recognition processes can be nested and/or hierarchical in nature. A nested recognition process allows for hand drawn structures nested inside other structures to be recognized independently. In FIG. 3, for example, the triangle and square could be analyzed before the block labeled SYS, given they are nested inside a larger oval-shaped balloon. Hierarchical recognition is done by following rules that specify hierarchies among symbols, strokes, and/or parts of graphs, and recognizing and/or transforming those elements in the top of the hierarchy before the other elements lower in the hierarchy.

3. Users can be queried during the recognition process to correct recognition mistakes, to resolve ambiguities, to define certain icons or symbols, to fill in desirable extra information, etc., to help in the recognition. The present invention thus allows the recognition process to be extremely interactive, if desired.

4. The function and operation of rules used in a recognition process may be designed according to the type of problem specified and the objectives of the recognition process. In FIG. 3, for example, assuming the original diagram represented a simulation, the intermediate graph representation could be executed to provide simulation results. The final tree representation could be used to classify and index the graph. Further detail in this regard is provided later herein.

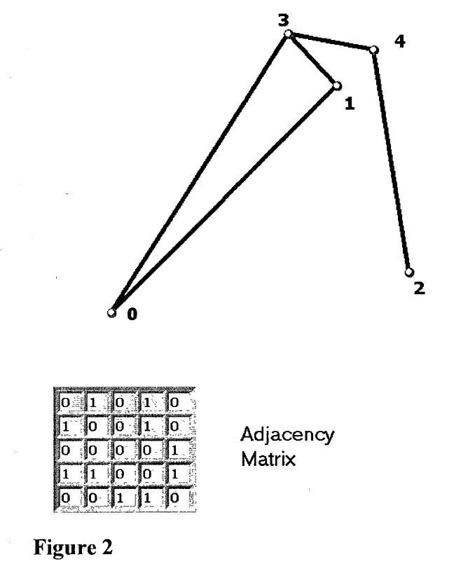

A graph as illustrated in FIG. 3 may be stored in computer memory in the form of an adjacency matrix. An adjacency matrix provides a data structure that records the arrangement and relationship(s) between nodes in a graph. For a simple example, as shown in FIG. 2, a graph with five nodes (say, numbered 0-4) may be represented in computer memory by a 5×5 matrix, each “column” and “row” of the matrix corresponding to a node in the graph. For a simple, undirected graph, the corresponding adjacency matrix may use the value “1” to signify an edge between nodes and the value “0” to signify no edge between the nodes. In the example in FIG. 2, assuming there is an edge between node 0 and node 3, for instance, the adjacency matrix has a “1” recorded in a memory location representing the first row (node 0), fourth column (node 3). A “1” may also be recorded at the memory location representing the fourth row (node 3), first column (node 0). For more complex graphs, more complex adjacency matrices may be used, particularly where semantics are attributed to the edges between nodes. In this patent document, “adjacency graph,” “adjacency matrix,” and just “graph” or “matrix” are used interchangeably and identify the same thing: a graph that represents the originally-specified problem.

Note also that a graph representing an original diagram can have nodes that do not necessarily map directly to a drawn object in the diagram. For instance, in FIG. 3, the presence of “SYS” in the original diagram is not necessarily mapped to a particular node and thus is not specifically labeled in the first intermediate graph. The semantic meaning of “SYS” is later combined into a node as labeled in the second, reduced graph in FIG. 3.

Rules

In embodiments of the invention illustrated herein, rules are used to create, manipulate, and simplify graphs that represent the original problem. Rules are conceptually viewed as having a left side and a right side. The left side of a rule specifies a condition or property to be met. For example, the left side of a rule may specify a pattern that may be found in the graph. The pattern specified may depend on context, edge, and/or node properties or other conditions in the graph. The right side of a rule specifies an action to be taken if the left side condition or property is met. For example, the right side may specify a simplified graph structure that is substituted for the left-side pattern when the left-side pattern is found in the graph. Left side conditions may be specified by first-order and/or higher order logic. Different strategies can be used in the invention to match and replace graphs or hypergraphs (see, e.g., Ehrig [1997, 1999]). Note also the rule extensions discussed below.

Static rules, dynamic rules, and/or heuristics can be applied to an entire graph or to any part of a graph. This flexibility allows specific parts of graphs to be independently analyzed. In turn, the results from a rule-based substitution can be used to prune other parts of the graph, which may speed up and increase the accuracy of the overall recognition process.

The rules applied at all stages may further involve consulting external databases or other mechanisms to remove ambiguity, if desired. These external databases may be stored locally in the computer or at a remote computer. Moreover, these databases may be created by the user or may be predefined by third parties. Nevertheless, in some applications, ambiguity in the final representation may be acceptable, as discussed further below.

Because dynamic rules may be used in a recognition process according to the invention, the rules used can be augmented or modified on-the-fly during a recognition process. This permits customization of the rules based on specific applications or results of the recognition process, user preferences, etc., while the recognition process is taking place. In one aspect, modification of rules may be accomplished by applying one or more rules constructed from observing specific situations or user behavior. For example, if a certain ambiguity needed resolution, a user could be queried to resolve the ambiguity. After a few such queries, if a repeated ambiguity and resolution is observed, a rule may be automatically modified and/or added to the rule set to automatically resolve the ambiguity when it next occurs.

Dynamic rules can be used in association with static rules to manipulate graphs and also to generate new rules and/or heuristics, based on the recognition process being conducted. Using dynamic rules with static rules allows for very efficient methods, e.g., for debugging previously drawn diagrams or allowing users to dynamically modify their prior input.

It should be understood that the rules used in the present invention are not restricted to any particular language or syntax. Rules may use the syntax of predefined standard programming languages. Alternatively, rules may be based on a custom-made language that has its own unique syntax and semantic meaning. Different applications using the present invention may have their own “rule” language. The sample rules shown in FIGS. 7, 8, 16, and 19 are written in a custom-defined language.

The generic scheme of the invention discussed herein can be used to recognize and interpret diagrams, formulas, and other graphical representations in a computer. In most cases, the objective of a recognition process according to the invention is to obtain a non-ambiguous representation of the original diagram. Handwritten or hand drawn diagrams are informal and sometimes the user's intentions are not clear, even to trained professionals. Generally, if an intermediate ambiguous representation cannot be resolved, a set of options may be presented to the user who can then resolve the ambiguity according to his or her intentions. Nevertheless, ambiguous representations can be accepted in the final result of the recognition process. For example, a diagram could be ambiguous in that the meaning of some symbols are not yet defined (for example, the symbol marked “1” in FIG. 3 could be later defined).

Certain applications of the invention are presented herein. For example, a formula recognizer is presented. Other applications are demonstrated in which specific problems are addressed. Some of these applications involve maintaining ambiguous representations, or arrangements, and others involve non-ambiguous formal representations as a final objective. Prior to discussing these applications, additional background and detail regarding recognition aspects of the invention are provided.

Generalizing Graph-Rewriting Systems

Recognition processes of the present invention are based, in part, on a generalization of graph-rewriting operations. The theory of graph-rewriting is a natural generalization of string grammars and term rewriting systems. The state of the art in that regard is presented in Ehrig [1997] and Ehrig et al. [1999]. Typical graph rewriting systems are context-free and replace nodes, edges, and sub-graphs with other sub-graphs.

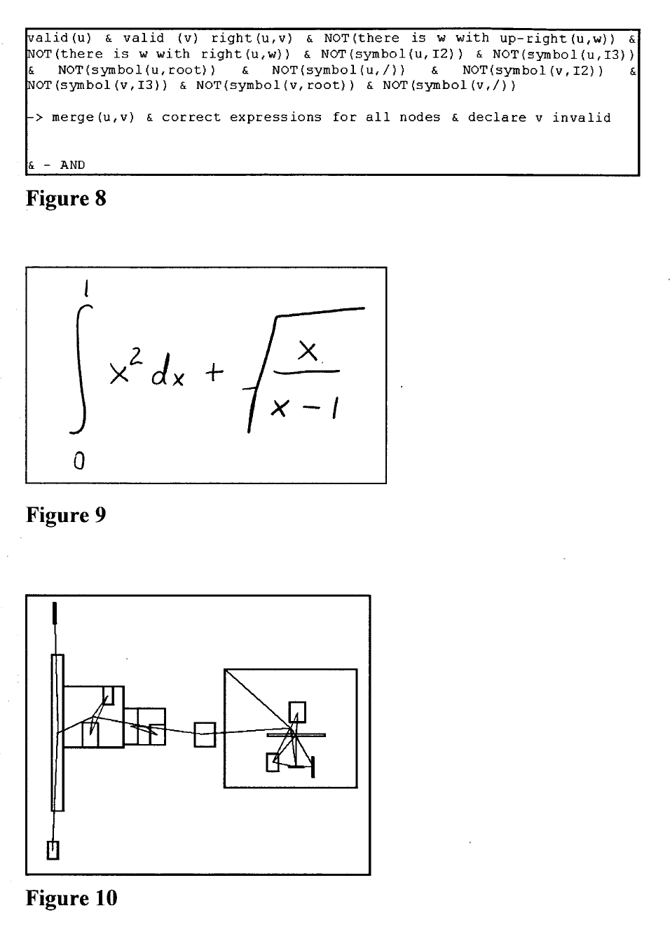

As illustrated in FIGS. 7, 8, 16, and 19, for example, the present invention uses rules that build on standard graph-rewriting procedures (depending on the application under consideration), with geometric and graph-independent constraints (see, e.g., the first rule in FIG. 7) or by first-order logic predicates (see, e.g., FIG. 8). Generalized graph-rewriting operations are used in the present invention to handle specific recognition tasks that are highly context-sensitive, where geometric aspects are also important. For a specific recognition task, the complexity of the underlying graph-rewriting rules depends strongly on the characteristics of the problem itself and can vary considerably.

As noted earlier, rules conceptually have a left side and a right side. If the conditions on the left side of a rule are met (e.g., a specified pattern is matched), the right side is executed (or applied) to the problem (e.g., by replacing the matched pattern or graph with another pattern or graph). The process of executing or applying a rule when the left-side conditions are met is otherwise referred to herein as “applying” the rule or as a rule “firing.”

Static Rules and Rule Sets

In accordance with the present invention, static rules may be augmented with the following characteristics:

1. A rule firing can be determined by specifying first and higher order logic statements together for the left side of the rule.

2. A rule firing can also be determined by methods (or programs) that execute at runtime or are executed by an interpreter or other program component associated with the recognition process. The outcome of the interpreter defines whether the rule should be fired.

3. The conditions on the left side of a rule can be met using a variety of different criteria, beyond isomorphic pattern matching. For example, a rule could be fired based simply on the existence of common nodes between the graph under analysis and the graph specified in the left side of the rule. For another example, a match between a pattern forming the left side of a rule and a pattern in the graph under analysis may be found by first transforming both into spanning trees or spanning graphs prior to comparison.

4. Rule sets may be formed by associating together two or more rules. Firing conditions and methods can be specified in the same way for a rule set as for individual rules. For example, where the original problem concerns symbolic computation, a rule set can be specified that applies the rules in the rule set to any symbolic computation involving trigonometric functions. Such a condition for the rule set can be specified using first order logic.

5. Hierarchical rules and rule sets may be defined. A hierarchical rule specifies a hierarchy among the firing conditions of the rule. A hierarchical rule set specifies a hierarchy and/or order in which the rules in the rule set are to be applied. One typical hierarchy is a tree (e.g., start at the root and check to apply each child rule if the parent rule was fired). Another hierarchy is accomplished by specifying a rule firing order based on an importance value assigned to each rule. Rules whose left side conditions are met may be applied in order of the importance value assigned to those rules.

6. Nested rules and rule sets may be defined. A nested rule includes another rule as a firing condition. A nested rule set allows the specification of rule sets inside rule sets.

7. Rules may be considered (i.e., checked to see if they apply) by following a method or program that can be executed by the recognition system. The method or program can be another rule (as with nested rules above). For example, a rule could be associated with a program that instructs the program to continue running until the rule is determined false. As another example, a graph relationship between rules could define a rule set. The rule set could be applied by following a path of firing nodes on this graph.

8. A state machine may be associated with a rule set. Typically, a rule set is applied in a linear, sequential fashion with the firing of each rule affecting the graph under consideration. Using a state machine simply generalizes this concept to allow one to have a “program” decide which rules should be applied in which order. Each state in the state machine may be defined to correspond to a rule or rule set to be applied. At each state, the rule or set of rules for that state is checked to see if they can be fired. State transitions in the state machine occur when defined conditions are met, such as if the rule associated with the state was fired. State transitions may also be based on metrics on the graph that results from a rule firing and/or any other property that is available at the time. When arriving at the next state, the rule or set of rules associated with that state is checked and the recognition process continues. Checking a rule, in this regard, signifies trying to parse the graph with the rule, and if the rule fires, modifying the graph accordingly.

9. Parallel rules or rule sets are defined where certain rules or groups of rules are not fired before or after each other, but are considered simultaneously for firing. The rule or rule set that is actually fired may be determined by resolving conflicts between the rules or rule sets whose left side conditions are met. For example, consider a case where a circle drawn inside another circle has two meanings: one is that the combined circles represent the digit zero, and the other is that it represents a wheel. Two sets of rules may apply, one to each case. However, if one rule set is applied before the other, the recognition process may not distinguish the appropriate meaning of the combined circles. In such cases, the rules should be considered in parallel. In one embodiment of the invention, a hierarchy is defined to determine an appropriate order for considering parallel rules. The hierarchy may use a partial order to order the rules. Rules at the same level in the hierarchy are considered, but not yet applied (that is, the left sides of the rules are checked to see if the conditions are met). All rules or rule sets whose left side conditions are met are kept in a list. Conflict resolution is then used to determine which rules or rule sets are to be applied. The particular conflict resolution method used may depend on which rules apply. It may also depend on the potential outcome of the conflict resolution. Two exemplary methods of resolving conflicting rules are based either on context (determining, for example, whether the conflict has been resolved before and if so, how was it resolved) or user inquiry (asking the user to specify the resolution). Recalling the example described above, it would be more consistent to recognize the circle within a circle as a number than a wheel if it is located within a string of numbers. Once the conflict is resolved, the appropriate rules or rule sets are then applied.

Dynamic Rules and Rule Sets

Static rules are used in graph rewriting systems known in the literature and in commercially available products. A static rule is predefined and cannot be changed at any point during program execution. Static rules that are subject to modification are not modified in between program execution (if a plurality of processes are executed). In some systems, dynamic components may be added beforehand using other frameworks such as Bayesian Networks, but even then they are not allowed to change at runtime.

In the recognition scheme of the present invention, the notion of a rule is generalized. A dynamic rule is a rule that can be manipulated at any time before, during, or after the recognition process in conducted. The rule can be augmented, altered, further specified, reduced, etc. Often, a dynamic rule according to the present invention is modified based on heuristics. A dynamic rule set is a set of dynamic rules that can be augmented, altered, further specified, reduced, etc.

Characteristics of dynamic rules, in accordance with the present invention, include the following:

1. A dynamic rule can be modified in any manner (e.g., augmented, altered, further specified, reduced, etc.). Rule modifications may apply to the left side of a rule, to the right side of a rule, and/or to any other property or method associated with a rule. For example, first order logic statements specifying when a rule is applied can be changed based on specific information or results produced during the recognition process or by consulting external databases or the user.

2. A dynamic rule may be changed by a method or program component in the computer. The method or program component may be static or encoded at runtime and interpreted with an interpreter program associated with the recognition progress.

3. A dynamic rule may be changed by applying a rule to the left and/or right side defining the dynamic rule. A rule may also be applied to any other aspect that defines the dynamic rule.

4. Rules and methods that change dynamic rules can be fired based on the firing of any other rule or rules. In some embodiments, recursive and hierarchical chains of rules or rule sets are defined to determine when a collection of methods and/or rules that change a dynamic rule or rule set needs to be fired. For example, logic statements involving rules previously fired or not fired can be used to trigger the execution of methods that change the dynamic rules.

5. A dynamic rule set can be changed by associating a second set of rules and/or heuristics that are applied to the patterns, conditions, and/or properties of rules in the dynamic rule set. Changing a dynamic rule set may include removing rules and/or removing conditions on the dynamic rule set for applying the rules. It may also include adding rules and/or conditions of application to the rule set.

6. Dynamic hierarchical rules and rule sets can be defined. A dynamic hierarchy between rules or between the firing conditions of a rule is a hierarchy that can be modified before, during, or after runtime by programs, methods or other rules. One example is a rule set that has each rule augmented by an integer value initially set to zero. A method is defined with the rule set that increments the integer value of a specific rule when that rule is fired. A dynamic hierarchy is then maintained by a method that sorts the rules in the rule set by this value. The rules in the hierarchy may then be sequentially applied, resulting in application of the “most fired” rules first or last, as desired.

The term “runtime” as used herein implies any time other than when the rule systems were first programmed, such as the time when a recognition process is being executed or a series of recognition tasks are being performed.

Generalizing Minimum Spanning Trees

Some procedures described herein use a generalization of the well-known minimum spanning tree algorithm as applied to undirected graphs. The minimum spanning tree (MST) of a graph defines the cheapest subset of edges that keeps the graph in one connected component.

Standard MST problem:

Input: An undirected (connected) graph G=(V,E) with weighted edges. V is the set of all vertices, or nodes, of the Graph G, and E represents the edges of G.

Output: The subset of E of minimum weight that forms a tree on V.

Fast algorithms such as Prim's Algorithm, Kruskal's Algorithm and Boruvka's Algorithm (Atallah [1999]) may be used in solving this problem.

For purposes of illustrating this aspect of the invention, two generalized MST problems are provided which can be used to solve graphical or diagrammatic recognition problems.

Generalized MST Problem 1—Minimum Spanning Graphs (MSG) in directed graphs:

Input: A directed (connected) graph G=(V,E) with weighted edges. V is the set of all vertices, or nodes, of the Graph G, and E represents the edges of G.

Output: The subset of E of minimum weight that forms a directed connected graph with the following property: For any two nodes of this MSG, there is a directed path that connects these two nodes. The direction of this path can be arbitrary, i.e., it is not required that the directed path start at a specific node.

Generalized MST Problem 2—Minimum Spanning Hypergraphs (MSH) in hypergraphs:

Input: A hypergraph G=(V,E) with weighted hyperedges. V is the set of all vertices, or nodes, of the hypergraph G, and E represents the hyperedges of G.

Output: The subset of E of minimum weight that forms a hypertree on V.

In this type of problem, two nodes are adjacent if and only if they share a common hyperedge. Two hyperedges are adjacent if and only if they share a common node. A hyperpath between two nodes in a hypergraph is a sequence of adjacent hyperedges that starts at the first node and ends in the other. A hypertree is a set of hyperedges where for any given pair of nodes there is exactly one hyperpath between them.

Recognition (Interpretation) of Handwritten Formulas

Turning now to various exemplary applications that demonstrate the use of recognition processes designed according to the invention, attention is first drawn to the problem of formula recognition. Formula recognition is merely one specific application of this invention. There are many other applications, some of which are described in detail herein.

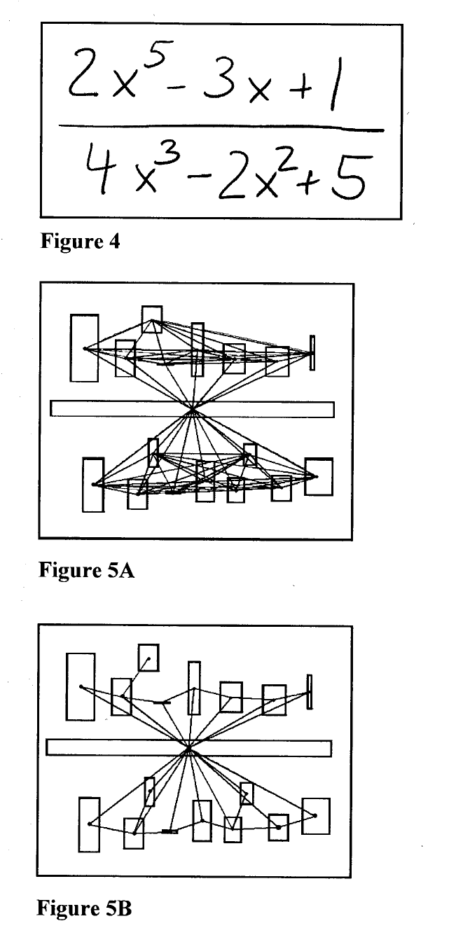

FIG. 4 depicts a typical handwritten formula. One recognition process according to the present invention recognizes a handwritten formula and converts it into a format that can be readily understood by standard mathematical software. One such format for the formula in FIG. 4 is the text string “(2(x)\hat{ }(5)−3x+1)/(4(x)\hat{ }(3)-2(x)\hat{ }(2)+5).”

Formula recognition is an important subtask in many other handwriting interpretation applications. There are two major parts to recognizing a formula. The first part is to recognize each symbol or number in the handwritten formula. This is referred to as symbol recognition. Symbol recognition can be accomplished using one of many known techniques, as discussed earlier, including pixel-oriented matching, shape-based or geometric-based matching, use of color or curvature of strokes, graph theory, and neural networks, for example. The second part is to understand the relationships between the recognized symbols and from that interpret the formula. As the symbols (including numbers) are being recognized and the relationships between them are understood, an adjacency matrix, or graph, is generated for the formula. For each symbol in the formula, the adjacency matrix, or graph, stores information about the spatial relationship of symbols to other symbols in the formula.

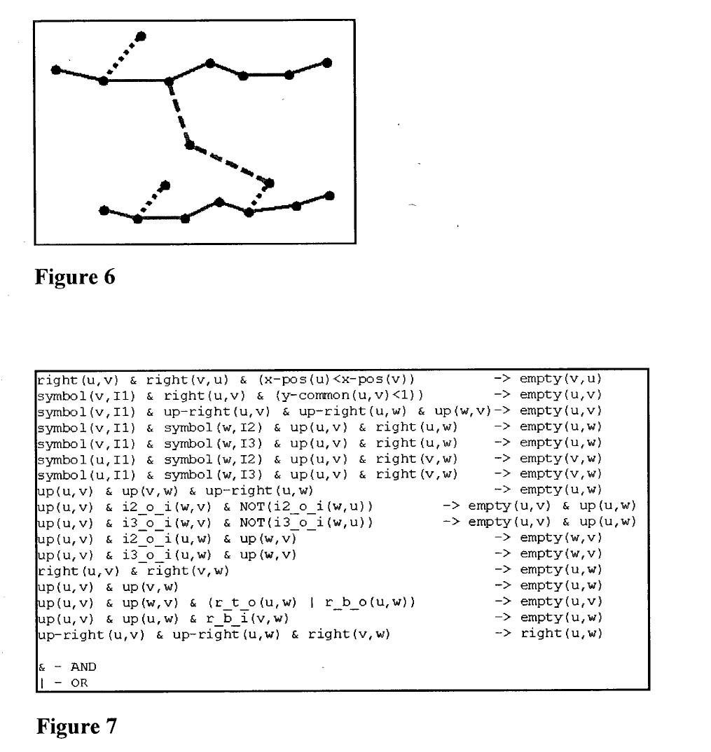

FIG. 5A depicts a graph of the formula in FIG. 4. The graph in FIG. 5A (internally represented by an adjacency matrix) may be simplified using rules that take into consideration that the original input is a formula. FIG. 5B depicts a simplified graph of the formula in FIG. 3. The boxes shown in FIGS. 5A and 5B surround the symbols as recognized in the original handwritten formula. The lines between the boxes represent relationships that may exist between the symbols. In this example, Kruskal's minimum spanning tree is then applied to the graph and a final minimum spanning tree representation of the original formula is obtained, as shown in FIG. 6.

The relationship between the vertices, or nodes, in the tree shown in FIG. 6 are associated with one or more adjacency classes. For the example in FIG. 6, the adjacency classes are “right” (shown in solid line), “up-right” (shown in dotted line) and “up” (shown in dashed line). In the numerator of the formula in FIG. 3, the symbol “x” has a right relationship with the number “2,” the number “5” has an up-right relationship with the symbol “x,” and the minus sign (“−”) has a right relationship with the symbol “x.” In this example, the semantic meaning attributed to each of the adjacency classes is simple. For more complex diagrams, such as those used in Simulink, the semantics may be more involved.

FIG. 7 depicts an exemplary selection of rules that may be applied to simplify a graph (or more precisely, the internal adjacency matrix representation). The characters u, v and w in the rules shown in FIG. 7 represent nodes in the graph. The predicates and functions of the rules are described in the text of the rules.

For example, consider the following rule shown in FIG. 7:

up(u, v) & up(v, w) & up-right(u, w)->empty(u, w)

The predicates “up” and “up-right” represent geometric relationships between the nodes. When a recognition process of the invention implements the foregoing rule, it checks the three conditions on the left side of the arrow “->”, and if the conditions are met, it applies the action on the right side of the arrow. Thus, if node v is above node u (i.e., “up (u,v)”), node w is above node v (i.e., “up(v,w)”), and node w is up-right of node u (i.e., “up-right (u,w)”), the last relation (in regard to nodes u and w) is redundant and is removed (by applying “empty (u,w)”). After firing all applicable rules, the adjacency matrix is expected to be simpler than it was before.

FIG. 8 illustrates an example of a resolution rule that can be applied to simplify an adjacency matrix. The characters u, v and w represent nodes in the matrix (graph). The rule shown in FIG. 8 resolves a valid “right” relation.

Recall that for a rule to be fired, the conditions on the left-hand side of the rule must be met. For the rule in FIG. 8, this first means that node u and node v must be valid, meaning that the nodes are available to be resolved. Nodes that are available for resolution are nodes in a graph adjacent to exactly one other node. In the rule in FIG. 8, nodes u and v must also be in a “right” relation to each other. The remaining conditions on the left-hand side of the rule in FIG. 8 state that the rule will fire if nodes u and v do not match the symbols as specified. If the conditions are met, the right-hand side of the rule (i.e., the portion following the arrow “->”) is applied, which in this case means that nodes u and v will be unified into a single node and node v will be declared “invalid” for further operations.

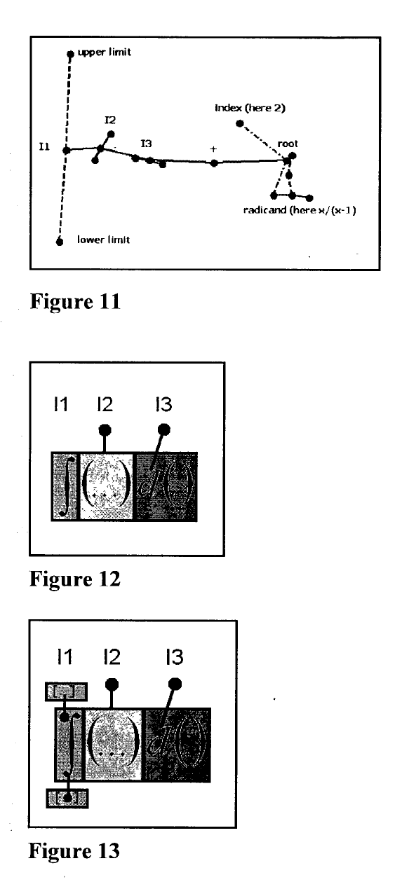

FIG. 9 provides another example of a typical handwritten formula. The formula in FIG. 9 includes both an integral and square root operations. As with the formula depicted in FIG. 4, the symbols (including numbers and meta-symbols such as “integral” and “root”) in the formula of FIG. 9 are first identified. In FIG. 10, boxes are shown surrounding each of the identified symbols. Furthermore, boxes around boxes in FIG. 10 reflect the nested nature of some of these symbols. For instance, at the right side of FIG. 10, a large box surrounds smaller boxes representing the symbols forming the radicand of the root operation. The lines extending between the boxes in FIG. 10 reflect the relationship between the symbols. In a formula, the geometric placement of symbols suggest the relationship between the symbols. For instance, the numbers “1” and “0” above and below the integral symbol suggests the limits of the integral. FIG. 10 thus depicts an intermediate stage in a recognition process that transforms the formula shown in FIG. 9 to the graph representation shown in FIG. 11. In one embodiment of the invention, the formula in FIG. 9 is ultimately recognized and output in computer-readable text as “int2((x)\hat{ }(2),dx,0,1)+((x)/(x−1))\hat{ }(1/(2)).”

FIGS. 12-14 further assist in understanding recognition processes performed according to the invention for the example shown in FIG. 9. FIG. 12 depicts the components of an integral. I1 stands for an identified integral sign. I2 contains the integrand which could be an arbitrarily complex expression. I3 represents the indeterminate plus the “d”-sign. I1, I2 and I3 are connected by “right” adjacencies in the graph shown in FIG. 11. I2 and I3 have additional adjacencies shown in FIG. 11 that reflect their specific content.

FIG. 13 depicts the components of an integral with bounds. A recognition process for an integral with bounds is similar to that for FIG. 12 but, additionally, the lower and upper limits of the integral are identified and represented in the graph that is generated. Both limits can be arbitrarily complex expressions. In the graph in FIG. 11, there is an “up” adjacency between the lower limit and I1 and another “up” adjacency between I1 and the upper limit.

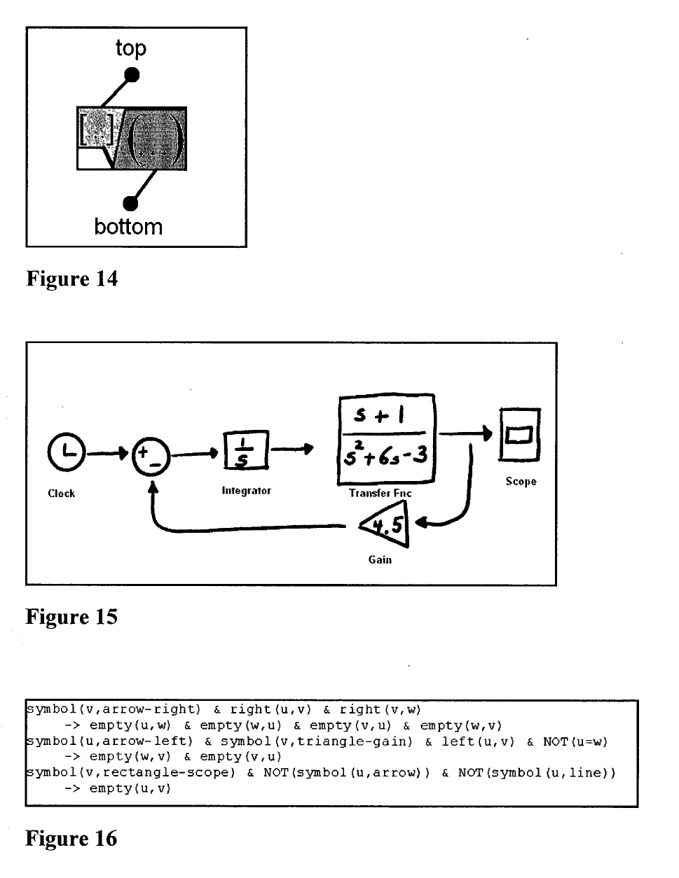

FIG. 14 depicts the main components of a root symbol. Both the index and the radicand of the root may contain arbitrarily complex expressions. Adjacencies between the index and the root and between the radicand and the root are defined, as shown in the graph in FIG. 1I. In the example of FIG. 9, the index of the root is 2 because the formula, as written, specifies a square root.

The recognition process identifies symbols (such as “x” and “2”), meta-symbols (such as “root”) and their relationships via their surrounding boxes. Using this information, a spatial order is built up and encoded in an adjacency matrix, or graph, as discussed above. For example, a “2” having an up-right relationship with “x” means “x\hat{ }2” (x to the power of 2), and a “root” that contains “x” (nested relationship) means “sqrt (x)” (square root of x).

Once the adjacency matrix is set up and includes the spatial relationships obtained from the original formula diagram, the next task is to reduce the matrix, preferably to a single node in this instance that represents the whole formula. To do this, reduction rules are applied to the graph in a temporal order. For instance, in one implementation of the invention on a formula containing integrals, roots, and other symbols (e.g., as in FIG. 9), reduction rules are applied starting with integrals, followed by roots, and then the remaining symbols. Starting first with the integral symbol(s), all expressions pertaining to the integral (i.e., that have a spatial relationship indicating they are part of the integral operation) are reduced and preferably translated to a textual representation (such as “int( . . . , . . . , . . . )”). This textual representation may be contained in a single node.

Following integrals, root symbol(s) and all expressions pertaining to them are reduced and preferably translated to a textual representation (such as “root ( . . . , . . . )”). This textual representation may be contained in a single node that is linked to the integral node. Remaining symbols and expressions are then reduced and preferably translated to textual representations based on the relations specified in the adjacency matrix. For instance, symbols having a “right” relation are reduced first, followed by symbols having “up” relations, then by symbols having “up-right” relations, in that order.

An intermediate reduced graph may have several linked nodes with textual information in each node. Rules may then be applied to this intermediate reduced graph to reduce it further, possibly to a single “super node” that contains the textual representation of the whole formula.

“Algorithm A” for Recognition of Handwritten Formulas:

To illustrate one exemplary embodiment of the invention, an algorithm utilizing principles of the invention for recognizing handwritten formulas in provided as follows.

Input: A list of strokes that forms the symbols in the formula under consideration. Each symbol in the handwritten formula may contain one or more strokes.

Output: A syntactically correct expression for the formula under consideration.

Given the foregoing input, the following tasks may be performed.

(A.1) Group strokes together that belong to the same symbol. Strokes belong to the same symbol if the distance between them, as written, is small (i.e., below a threshold).

(A.2) Identify each symbol and construct a border surrounding the symbols (e.g., the boxes shown in FIGS. 4, 5, and 10).

(A.3) Recognize and construct borders around meta-symbols such as integrals and roots, including borders that nest the symbols of the operation pertaining to the meta-symbol. Symbols and meta-symbols may be represented by nodes in the graph being constructed.

(A.4) Generate a first adjacency matrix, describing relationships between symbols, meta-symbols and their surrounding boxes. The order in which symbols, meta-symbols, and their surrounding boxes are resolved is specified by their location and orientation in the original input (see, for example, the formula in FIG. 9). The following relations (and their corresponding meaning) were used in one implementation of the invention on the formula shown in FIG. 9:

right—two symbols have a left-right order;

up-right—one symbol is up-right of the other;

up—two symbols have a bottom-up order;

r_top_in—connection between root symbol and index (FIG. 14);

r_top_out—connection between index and root symbol (FIG. 14);

r_bottom_in—connection between root symbol and radicand (FIG. 14);

r_bottom_out—connection between radicand and root symbol (FIG. 14);

i2_outer_in—connection between integral and integrand (FIG. 12, FIG. 13);

i2_outer_out—connection between integrand and integral (FIG. 12, FIG. 13);

i3_outer_in—connection between integral and indeterminate (FIG. 12, FIG. 13).

(A.5) Apply a series of transformation rules (see e.g., FIGS. 7 and 8) that simplify the adjacency matrix. Most rules result in deleting redundant or unnecessary nodes and/or edges; some add new nodes and/or edges. Some rules are completely based on the content of edges. Other rules take into account symbol information and geometric components (e.g., size or location of symbols). The result is a simplified graph where redundancy is reduced or eliminated. Compare FIG. 5B to FIG. 5A as earlier discussed.

(A.6) If the resulting graph is a minimum spanning tree, go to (A.8). If not, add weights to the remaining edges. The value of the weights may be set such that the lower the weight, the more likely the edge will be chosen for the spanning tree process described in (A.7) and (A.8). In one exemplary implementation, the weight function adds penalties based on the following order (increasing weights):

right—weight depends on the distance between the underlying symbols as originally written by hand;

up—weight depends on the distance between the underlying symbols, with a penalty for integration symbols;

up-right—small fixed weight;

root,

r_top_in,

r_bottomin,

i2_outer_in,

i3_outer_in—medium fixed weight;

r_top_out,

r_bottom_out,

i2_outer_out—large fixed weight.

(A.7) Construct a minimum spanning tree of the weighted adjacency matrix (see e.g., FIG. 6 and FIG. 11). Techniques for constructing a minimum spanning tree from a weighted adjacency matrix, or graph, are known in the art, as discussed earlier.

(A.8) Resolve the minimum spanning tree, for example, by one or more reduction processes, and generate a syntactically correct representation of the handwritten formula being recognized. In one exemplary implementation, a spanning tree is reduced according to the following schema written in pseudocode:

while reduction takes place

while reduction takes place
begin

reduce “right” neighbors
reduce “power of” neighbors
reduce “up” neighbors
reduce “root” neighbors

end
while reduction takes place
begin

reduce “integrals” neighbors
reduce “integrals with limits” neighbors

end

end

A reduction step takes place if the conditions of rules are met and the rules can be applied to the spanning tree. See, for example, the selection of rules in FIGS. 7 and 8. The final spanning tree representation may be reduced to form one “super node” that embodies an expression, such as “int2((x)\hat{ }(2),dx,0, 1)+((x)/(x−1))\hat{ }(1/(2)),” which represents the original problem and is widely understood by off-the-shelf computing software. It should be understood that this algorithm (designated “Algorithm A”) is only one example and many such algorithms may be prepared according to the principles of the present invention.

Recognition (Interpretation) of Hand Drawn Visual Programs

Many visual programming tools are currently available on the market. Well known tools include LabVIEW™, Simulink®, AGILENT-VEE™ and UML™. In visual programming environments, a program is represented by a combination of diagrams and textual inputs. The diagrams may be specified, for example, using a mouse or keyboard input. A diagram is formed by connecting icons or shapes together using lines or other forms of connecting elements. The icons represent instances of sub-programs, elementary programming constructs and routines offered by the visual programming language. In some environments, the sub-programs can be specified by textual information.

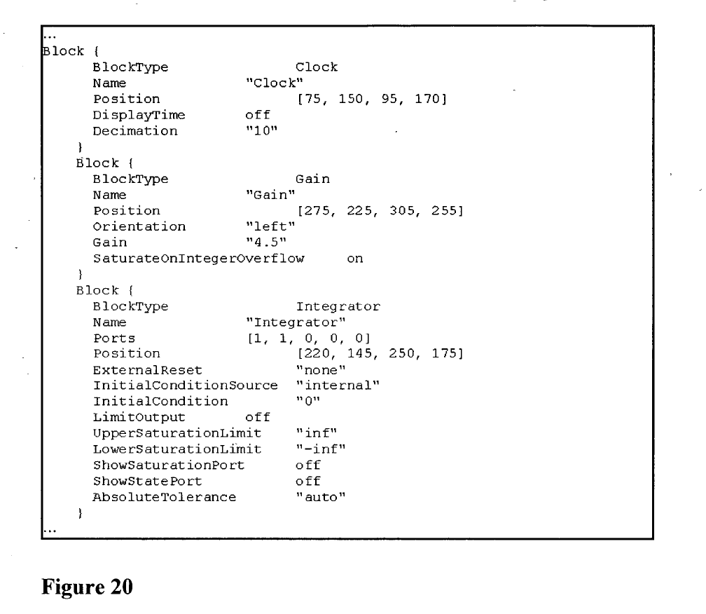

Once a visual program is defined, it can be compiled, run and analyzed much in the same way as textual programming languages, such as C or FORTRAN. The visual program can also be converted into programs that use common text languages. This conversion process is often called code generation. See, for example, the Simulink® code shown in FIG. 20.

Pen-based interaction with visual programming environments enhances the capability of users to interact with such visual programming environments. For such capability to be available, however, a reliable and flexible recognition engine is necessary. The recognition and interpretation engine presented as part of this invention is such a procedure.

A distinct advantage of pen-based specification of visual programs using visual programming tools is that most visual programming languages have a relatively formalized set of icons, primitives and structures that are used to write a program. Moreover, the programming is also formalized, and easily translates into the scheme of the invention presented herein. A pen can also be used to interact with existing formal programs, or programs that are being incrementally recognized and converted into a formal representation.

The formal representation of a visual program is a representation that is understood by the visual programming environment or a representation that can be easily converted into a program understood by the visual programming environment (such as a text file specifying a diagram). In visual programming, structures that group icons together are called containing structures.

One exemplary method for handling the recognition of visual programs in accordance with the present invention incorporates the following principles:

1. Hand drawn diagrams can be recognized as they are drawn. Each time a containing structure is defined (containing structures are execution structures such as “for” and “while” loops, sequence structures, case structures, etc), the elements and connections internal to that structure can be identified. Using the recognition and interpretation framework proposed herein, this means executing one or more recognition processes to recognize the elements that are bounded by the structure.

2. Symbols, including icons and programming constructs, can be represented by simplified drawings. For example, a simplified representation may be a timer that is defined by drawing box and a quadrangle inside it (compare the lower right drawing to the upper right drawing in FIG. 25 for a LabVIEW programming construct). Permitting simpler representations not only reduces recognition complexity, but more significantly, reduces the burden on the user. The user can draw much less and still achieve his intentions.

3. Hand drawings may be combined with other input mechanisms. For example, once a symbol representing a programming construct is drawn and recognized, the user could be presented with a series of options from which to select to further specify the intended programming construct. The options presented may be based on the programming constructs available in the formalized libraries of the visual programming environments. For example, if a “constant” box is drawn (recognized by its size, for example), a small number scroll input could be immediately displayed to assist the user in specifying the numerical value of the constant. Also, it might be more convenient to the user to specify labels for programming constructs using alternative input mechanisms. Such enhancements to the purely hand drawn approach can be used as desired.

4. For recognition purposes, an element in the diagram need not be completely drawn. Some elements of formal structures can be omitted. The recognition process (as well as the human eye) can understand partial diagrams due to the formalism of the language underlying the visual programming environment. A diagram with partially drawn elements can be recognized as a particular programming construct, or icon, for example, because the elements of the drawing (icon) do not represent part of any other icon in the visual programming environment.

5. Visual programs can be debugged using pen inputs. Using a simple expression language and the elements of the visual program, a natural debugging mechanism becomes available. Standard debugging tools such as breakpoints, highlighting values and conditionals, can be visually specified by hand drawn input. For an example, see the LabVIEW section below. Additional interaction mechanisms with greater complexity can be added. Alternative inputs to subprograms in a program can be specified to override the standard inputs, conditional breakpoints can be defined using grouped drawings and handwritten conditions, stop points in the programs can be specified by marking dots in the corresponding visual program, etc. Pen-based annotations in the visual program can define subprograms used exclusively in debugging.

6. Stroke color can also be used to enhance the recognition system. Color can be used, for example, to specify interaction modes in a visual program. For example, black may represent program constructs, blue may represent program inputs and red may represent debugging structures. A recognition process according to the invention that recognizes the color of symbols may act accordingly. In the above example, when generating a graph representation for a black symbol, the recognition process may use information limited to program constructs. Likewise, for blue symbols, the recognition process may use libraries intended for program inputs, etc.

7. Relationships between visual programs can also be specified using pen inputs. For example, grouping icons (representing sub-programs) together in a visual program using a circle may result in creating a new sub-program that replaces the selected nodes with the new sub-program. The new sub-program contains the selected nodes as its own specification.

8. Visual program execution schemes can be defined using a pen input. For example, once a complete visual program is specified, a part of it can be executed using a combination of pen strokes and grouped drawings. Pen-based annotations in the visual program can also specify execution schemes, such as repeated execution of parts of a visual program.

Recognition (Interpretation) of Simulink® Diagrams

According to the general scheme discussed above, the first step in understanding Simulink® drawings (see Dillner [1999]), such as the drawing shown in FIG. 15, is to identify the symbols in the drawing. There are several main symbols, such as arrows (right, left, up, down), lines, rectangles, triangles and circles. Symbols that build up numbers, formulas, +/−signs, scopes, clocks, etc. are located inside the aforementioned symbols. To express relationships, a recognition process according to the invention may use predicates such as left, right, up, down, formula_in, formula_out, etc. These symbols, objects, and predicates are used to form a first adjacency matrix that represents the original simulation drawing.

FIG. 16 depicts a small selection of rules that may be used in simplifying an adjacency matrix. The symbol class “arrow,” for example, contains “arrow-left”, “arrowright”, “arrow-down” and “arrow-up”. This depiction of rules in FIG. 16 is merely an example of the kind of rules that a recognition process of the invention may use.

The final target representation in this example is a directed, executable graph. A minimum spanning graph (MSG) may provide a directed graph in that regard. This representation uniquely specifies the original underlying graph. The MSG is then easily translated into a Simulink specification because the structure is properly reconstructed and understood.

Hand drawn Simulink diagrams can be recognized according to the invention by recognizing curves, lines, characters and digits (i.e., symbols) in the diagram and producing a graph representing the same. As noted earlier, the initial intermediate graph identifies the symbols and the relationships between them. The graph (or more precisely, the adjacency matrix representation) may then be simplified using one or more rules. A simplified graph may include ambiguities if it contains elementary aspects, such as undefined strokes, that were not earlier resolved. In the case of Simulink diagrams, however, because the diagrams and programming environment are highly formalized, recognition of elementary aspects of the drawing is not usually necessary because the symbols are quickly identified with the formal programming constructs available in Simulink. But in alternative applications, recognition and resolution of elementary drawing features may be required.

Nevertheless, Simulink diagrams may contain arbitrarily complex formulas and for that reason, generic recognition processes according to the invention for Simulink diagrams may be at least as complicated as those for formula recognition tasks. If a Simulink diagram consists of independent and unconnected components, a set of minimum spanning graphs may be used to represent the diagram.

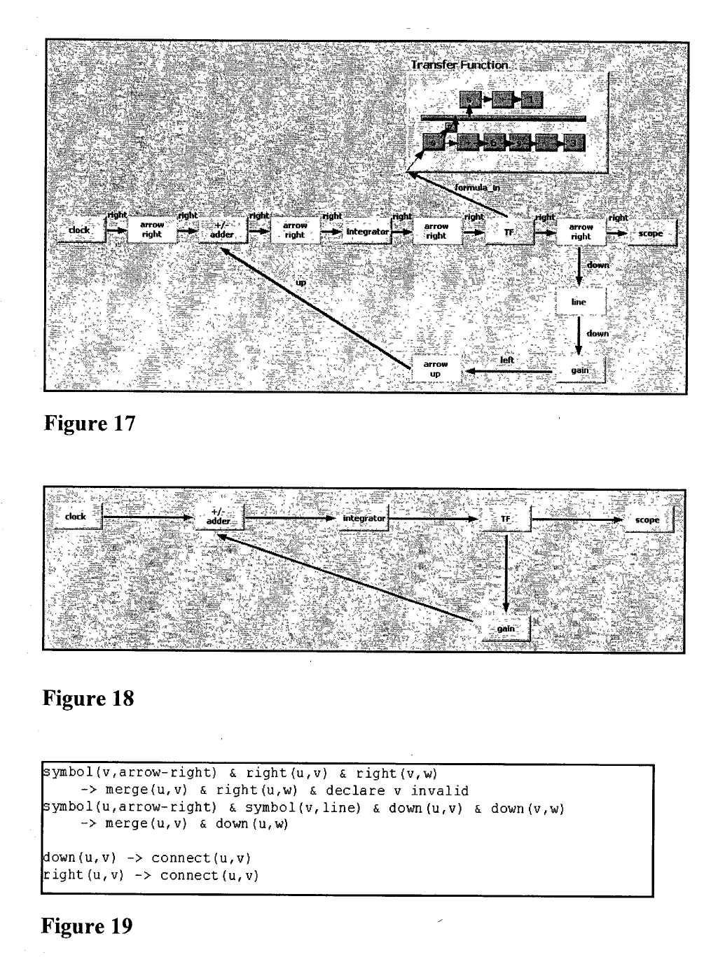

FIG. 17 depicts a directed minimum spanning graph prepared according to the invention to represent the Simulink diagram shown in FIG. 15. Certain nodes contain sub-structures. One such substructure (the transfer function) is shown. Some others are left out to simplify the graph for illustration herein. The “arrow-right”, “arrowup” and “line” vertices form a subset V′ of V (all vertices) that must have incoming and outgoing edges.

Recognition processes for Simulink diagrams usually result in the construction of a directed graph that appropriately represents the flow of data in the diagram. FIG. 18 shows the result of a graph reduction process according to the invention for the graph of FIG. 17. The graph reduction process is based on application of rules, as described herein. FIG. 19 presents a selected example of such rules. The last two rules shown in FIG. 19 belong to a family of rules that are applied when the first group of rules cannot be applied anymore.

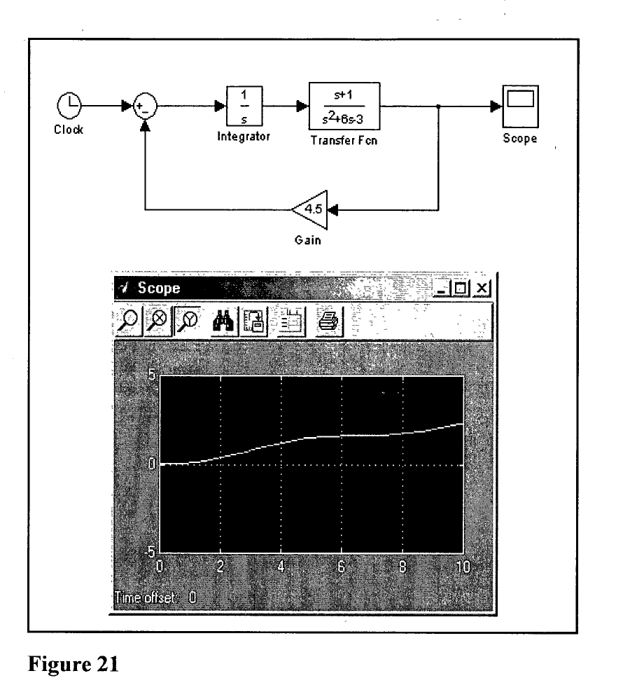

FIG. 20 shows an exemplary set of lines of grammatically correct Simulink code generated from the graph in FIG. 18. Numerical values for programming constructs not explicitly provided in the original hand drawn diagram or in an ambiguity-resolution stage employed by the recognition process may assume default values in the programming environment. The code generated from the graph can be interpreted and executed by the Simulink system. The result of executing this code is shown in FIG. 21.

Recognition (Interpretation) of LABVIEW™ Diagrams

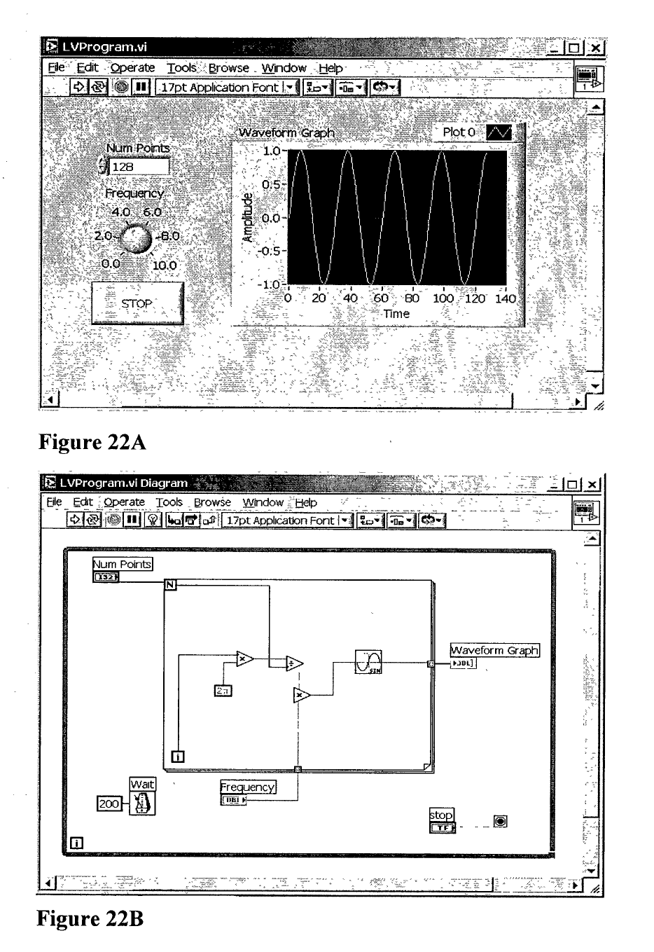

LabVIEW™ is a graphical programming environment developed by National Instruments. In LabVIEW, programs are specified by visual constructs in the form of a diagram. Visual constructs can be, for example, icons, structures, controls and indicators. Icons may represent functions or sub-programs. Structures are visual constructs that enforce relationships between icons and execution rules. Controls and indicators are presented in a front-panel and represent interactive elements of a program or a GUI (graphical user interface). FIGS. 22A and 22B illustrate a typical LabVIEW program with a front panel and a corresponding diagram. In FIGS. 22A and 22B, each active front panel element has a corresponding representation in the diagram. A LabVIEW program or icon in the diagram is denominated a Virtual Instrument (VI).

Due to LabVIEW's inherent visual nature, hand drawn diagrams provide a perfect input mechanism to specify programs. The computing language realized by LabVIEW is denominated G. LabVIEW's G language also offers a rich semantic context for disambiguation due to the rather formal nature of the language. For example, the relative connections between elements in the diagram or even the context in which specific structures are placed can be used to identify the hand drawn icons themselves.

Hand drawn input depicting a LabVIEW diagram, as well as a front panel, can be recognized and interpreted using a recognition process of the present invention. LabVIEW front panel elements are selected from a fixed set of possibilities. Therefore, sets of rules for diagram recognition in accordance with the invention can be defined well in advance. Many possibilities exist for interaction in a LabVIEW environment based on hand drawn input.

The visual program recognition framework previously presented herein may be enhanced as follows:

1. Simpler drawing representations for some or all of the corresponding LabVIEW programming icons may be accepted and adequately identified. For example, a simpler representation could be a timing mechanism that is defined by drawing a box and a quadrangle inside it (compare the upper and lower drawings on the right side of FIG. 25). Such simpler representations reduce recognition complexity and reduce the amount the user has to draw to specify his intentions. In FIG. 25, the upper row of symbols presents three well-known LabVIEW constructs: “Build Array”, Search ID Array”, and “Wait Until Next ms Multiple.” The lower row presents three simplified representations that can be drawn, identified, and incorporated into a graph representation in accordance with the present invention. The simplified symbols are much easier to draw which may be important in a pen-based computing environment.

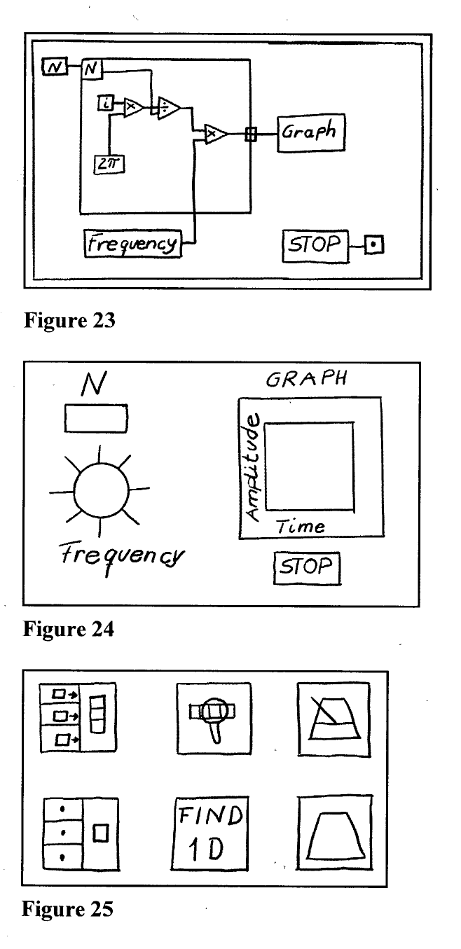

2. For recognition purposes, an element in the diagram does not need to be drawn completely. Hand drawn representations of FIGS. 22A and 22B are shown in FIGS. 23 and 24. Note that some elements of the formal loop structures have been omitted, for example.

3. Properties of LabVIEW diagrams can be specified based on graphical or diagrammatic inputs. For example, drawings can be recognized and incorporated into a graph and directly indicate information to be used as input into a program.

4. Hand drawings may be combined with other input mechanisms to specify a LabVIEW program. For example, once an icon, or symbol, is drawn and recognized, the user may be presented with a series of options from which to select. The options presented may be based on available LabVIEW icons. The options can be pruned depending on properties of the icon that were drawn, such as (but not limited to) the types of the elements connected to it. Also, the options presented to the user can be based on the natural groupings of icons on the icon palettes offered by the LabVIEW programming environment.

5. Execution of a LabVIEW Virtual Instrument (VI) can be initiated and controlled by pen-based annotations on the original underlying diagram.

6. Front panel elements can be drawn and recognized based on pen inputs (see FIG. 24). As they are recognized and incorporated into a graph representation, the controls and indicators in the drawings can be replaced by formalized versions of original LabVIEW controls and indicators, e.g., as shown in FIG. 22A. They may also be executed as separate drawings.

7. Relationships between LabVIEW programs (VIs) can be specified in the original underlying diagram using a pen input. For example, a VI hierarchy diagram can be drawn and read to build other VIs. Groups of VIs in a diagram can be circled and grouped into a single VI or into a VI library.

8. Formal and informal representations of a program can be combined in a single diagram. For example, in debugging a program, debugging annotations and code added to debug could be left as informal markings on the diagram as displayed, possibly in a color that signifies the informal nature of the markings.

Recognition (Interpretation) of AGILENT-VEE Diagrams

AGILENT-VEE™ (formerly known as HP-VEE) (see Dillner [1999]) is a graphical programming language that targets test and measurement applications. Compared to other recognition tasks discussed above (in particular, Simulink® and LabVIEW™), the underlying graphical structure of an AGILENT-VEE program is more complicated. As shown in FIG. 27, AGILENT-VEE diagrams combine data flow and control flow elements. Data flow elements are oriented horizontally, whereas control elements are connected vertically. In FIG. 27, the “For Count” and “Next” blocks represent elements that control the execution of the depicted diagram. Connector elements named “Low”, “High” and “Result” represent the flow of data as part of an execution process.

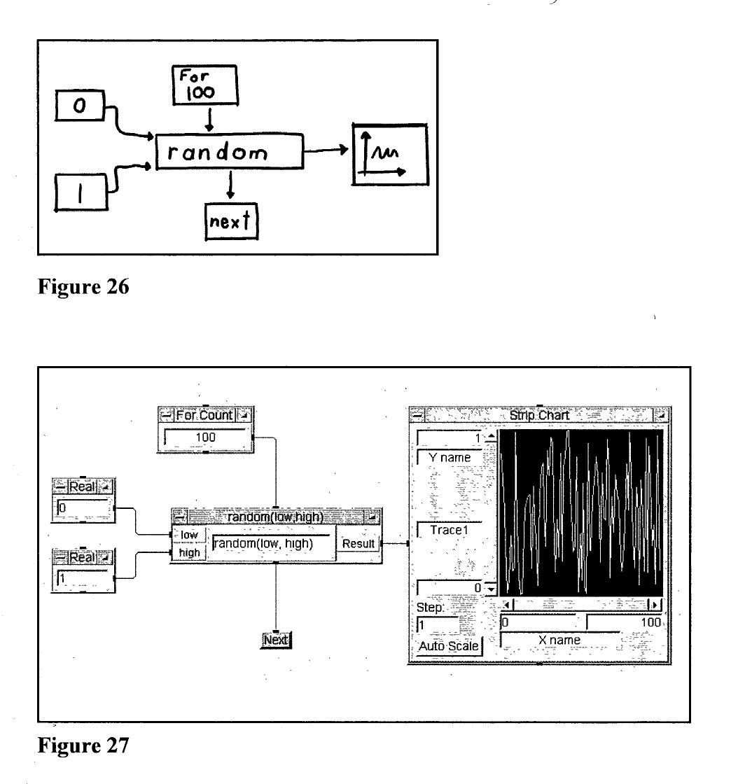

Such a distinction is important to a recognition process in this environment. A recognition process according to the invention analyzes hand drawn input, as shown in FIG. 26 and recognizes the symbols and their adjacencies using techniques as discussed earlier herein. The recognition process may deal with data flow and control flow separately (possibly in separate intermediate graphs) and combine the results to generate a grammatically correct program (FIG. 27) that is equivalent to the hand drawn version (FIG. 26). One possible implementation of this two-layer recognition task operates similar to the aforementioned recognition process in the Simulink environment. Graph-rewriting rules as defined according to the invention are applied to reduce the data flow and control flow parts into two directed graphs. The resulting directed graphs may then be used to produce a formal AGILENT-VEE program.

Recognition (Interpretation) of Hand Drawn Flowcharts

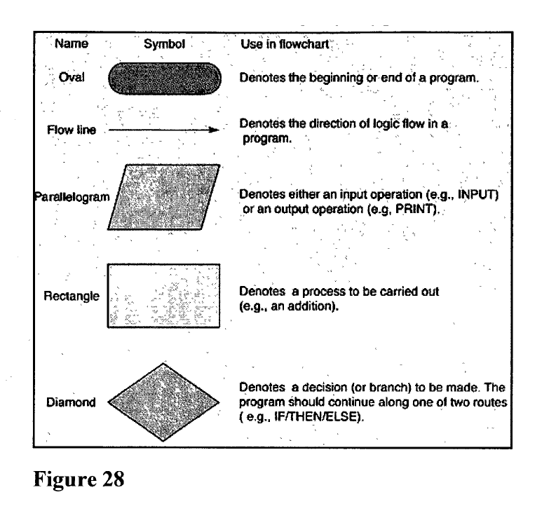

Flowcharts have been addressed from a graph-rewriting standpoint (e.g., Ehrig [1997] and Ehrig et al. [1999]). The formal grammar behind flowcharts is context-free and efficient parsers can be built up. Flowcharts are typically highly standardized, with a geometric appearance that is dominated by a very short list of standard elements. See, for example, the standard symbols in FIG. 28. Flowcharts are oriented top-down, in contrast to the aforementioned left-right oriented programming languages Simulink and LabVIEW.

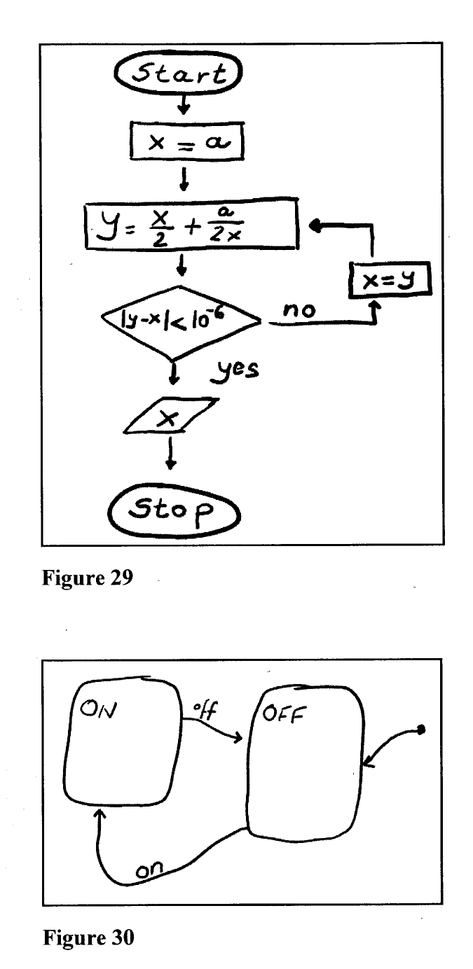

Because of possible feedback structures (for example, in FIG. 29, the “no” branch in the flowchart shown returns processing to an earlier block), recognition of flowcharts and Simulink diagrams, in accordance with the present invention, have much in common. The section above that describes processes for recognizing Simulink diagrams provides details that are applicable to flowchart recognition as well.

In one exemplary implementation, recognition of hand drawn flowcharts, as shown in FIG. 29, is a three-phase process. In Phase 1, the geometric shapes that form the main blocks of flowcharts are identified, along with the arrows and lines that connect the blocks. From that information, a graph with nodes and edges is generated to represent the flowchart. In Phase 2, recognition routines such as those developed as part of the formula recognition processes described above are used to recognize the content information in the flowchart blocks. See e.g., the formulas contained in the flowchart blocks of FIG. 29. Phase 3 combines the results of Phases 1 and 2 (i.e., adds the graph(s) representing the content information to the graph representing the overall flowchart). The graph may then be reduced and/or translated into a formally correct flowchart in a computer-readable format. The latter can be executed or translated, as needed, into various programming languages.

Recognition (Interpretation) Of Hand Drawn Stateflow Diagrams

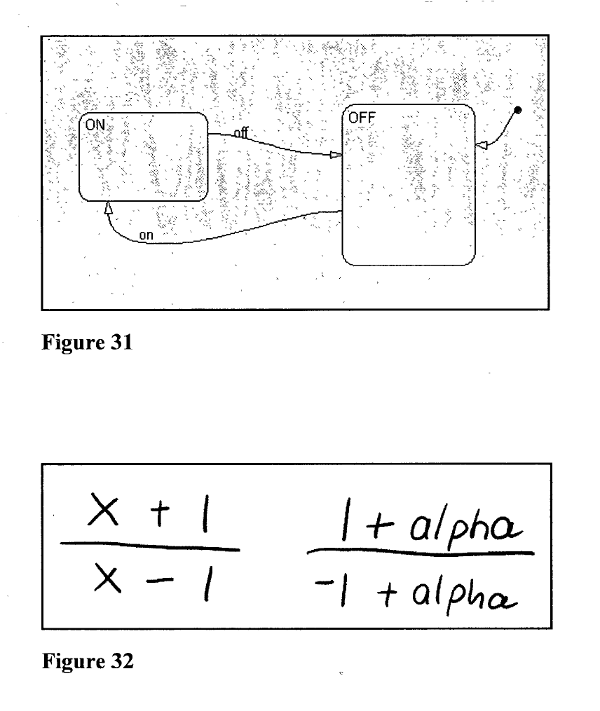

Recognition of hand drawn stateflow diagrams (FIG. 30) and their translation into grammatically correct computer-readable versions (FIG. 31) is similar to recognizing and translating hand drawn flowcharts. The principal differences are:

(1) Arrows and lines as connecting elements may be replaced with directed arcs. Recognition of directed arcs is generally more demanding than that of recognizing flowchart arrows and lines, but is still within the capacity of the recognition techniques discussed herein.

(2) Arcs are frequently marked by textual information. These text strings contain semantic information that is frequently used to correctly interpret the hand drawn stateflow diagram.

(3) Arcs do not necessarily have a beginning node that contains information. See, e.g., the rightmost arc in FIG. 31.

The generic scheme described above (recognizing graphical or diagrammatic input, creating a graph representing that input, and reducing the graph) can be applied to recognition of stateflow diagrams. For stateflow diagrams, it is preferred to use directed graphs to represent the original input diagrams. Rules used to create and reduce the graphs may take into account the textual information in the original diagrams, e.g., by adding weights to the graph that represent the semantic meaning of the textual information. In FIG. 30, for example, the two blocks representing different “states” contain semantic information. The lines between the blocks represent transitions between the states and also contain semantic information. As depicted, the “on” state may transition to the “off” state if the command “off” is applied. The latter is encoded as an edge in a graph that contains the semantic meaning (turn on-state off). A system in state “on” cannot be turned “on,” so there is no edge in the graph representing this transition.

Recognition-Based Searching and Indexing

The graphs generated during recognition processes according to the invention can be used to index objects and to search for objects in databases. This aspect of the invention is straightforward to understand and easily demonstrated for both formulas and Simulink diagrams. The principle to be understood here is that visually distinct graphical objects can generate identical canonical graph representations. This fact allows indexing and search operations to be performed using the canonical graph representations.

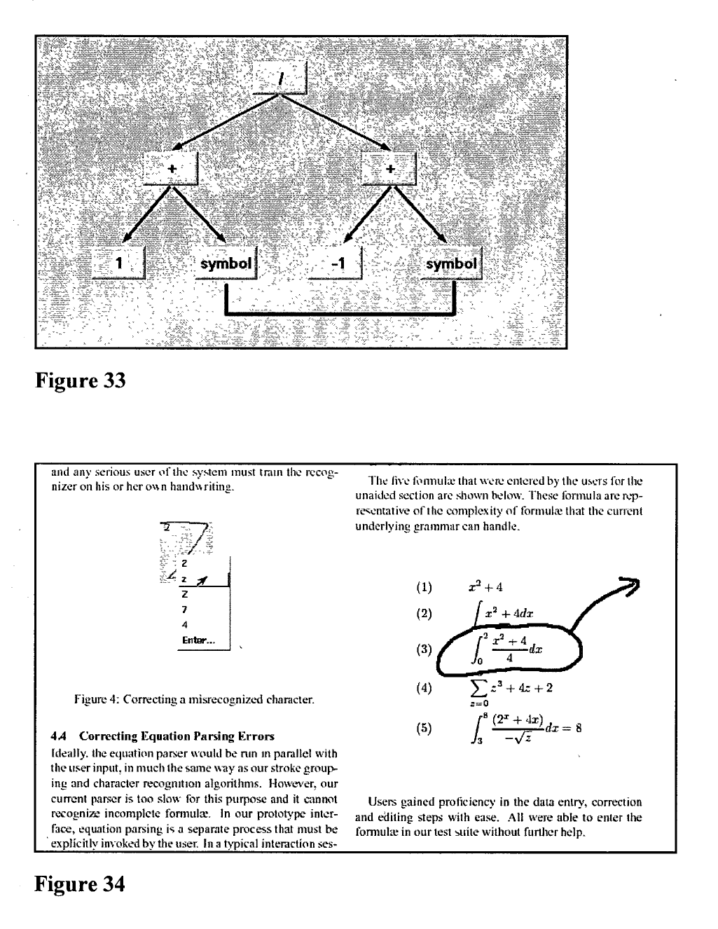

Consider the two formulas shown in FIG. 32. Symbolically, both represent the same objects as long as the symbols “x” and “alpha” are just placeholders for symbolic entities. In both cases, Algorithm A discussed above in the context of formula recognition generates a graph that, after simplification, produces the same tree shown in FIG. 33. The term “canonical representation” describes the fact that the resulting trees are equivalent. Additionally, a canonical representation can be augmented by lists of symbols used in a given formula or other graphical object.

A search operation, according to the invention, includes matching the canonical representation of an object (e.g., formula) being sought against canonical representations previously generated and stored in a database for other objects. The latter canonical representations may be computed in an earlier database preparation phase. A canonical representation thus acts as an index for the search operation. In most cases, simplification rules are applied to the intermediate graph(s) to obtain a canonical representation.

FIG. 33 illustrates a canonical tree representation for the formulas shown in FIG. 32. The use of meta-symbols (here “symbol”) is an umbrella for specialized occurrences of symbols (here “x” and “alpha”).

The situation is more complicated for Simulink diagrams. As noted before, the generic recognition scheme of identifying elements of a drawing, generating a graph representation, and reducing the graph, for a Simulink diagram results in a directed graph. In the directed graph, the nodes and edges incorporate semantic meaning of the Simulink diagram. Because the graph embodies information provided in the original diagram, the graph can be used as a generalized index for the type of diagram provided. The graph encodes the essential information of the diagram. The geometric position of objects and connections are not necessarily part of the encoding scheme. Using the graph as a generalized index, search operations can be operated on the index to match it with other directed graphs in which the graphs contain the same or similar information. As before, the introduction of canonical versions of these directed graphs simplifies matching routines. The problem of combinatorial explosion in search trees is avoided.

A generalized search problem can be solved with sub-graph isomorphism algorithms (e.g. Ullmann [1976]). Such problems arise when a graphical object (e.g. hand drawn formula, or Simulink diagram) is part of a larger graphical object of the same kind. One typical application of this scheme is a search for expressions, such as those shown in FIG. 32, as part of larger, more complicated expressions. A formula as shown in FIG. 32 may be found, for example, in an integral or as part of a sum of many other expressions. A similar situation can be observed when dealing with Simulink diagrams. For example, a typical application may involve finding all occurrences of the transfer function shown in FIG. 15 in a set of Simulink diagrams. A database holds the canonical representations of the Simulink diagrams, or parts thereof, for the search operation. Searching for a same or similar canonical representation of the object (here, an expression) will yield the desired result.

Recognizing Objects on a Screen

In numerous situations, one has access to electronically stored objects. Typical examples are electronic books, PDF or Word files depicted on a screen or Web sites rendered on a screen. In many cases, graphical objects are based on formal descriptions of the object content, e.g., formulas are described by MathML or TEX. But there are many other situations where the formal description or text content is completely lost. GIF, BMP or other graphical file types encode only the graphical appearance of objects and not the informational content of the objects. Recognizing and interpreting the information content requires as a first step a rendering procedure. The visually rendered object may then be analyzed and encoded into a graph according to the invention.

FIG. 34 illustrates an example of this process where part of a visually presented file is marked (here, with a circle and arrow) and the system employs a recognition process on the marked graphic to recognize the formula. The recognition process may translate the object, such as the formula circled in FIG. 34, into the form of a graph that can be used to manipulate, edit, calculate or post-process the object.

Sketch-Based Filter and Control Design

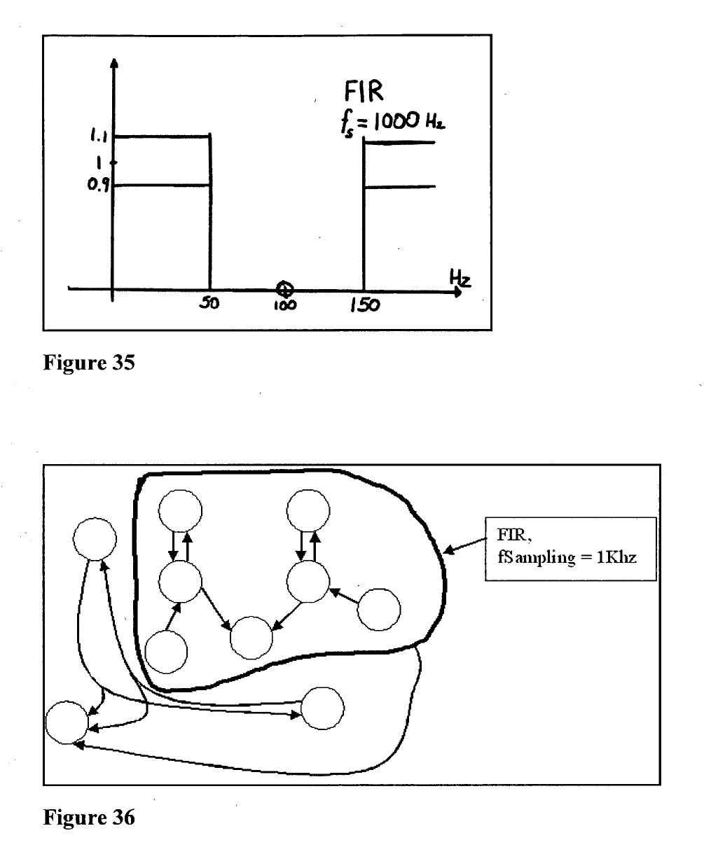

Interpretation of hand drawn diagrams can play an important role in designing systems. As an example, consider the task of designing a digital filter based on a sketch interface. Typically, a user would draw the filter requirements on a blank interface, and also annotate parameters of the design. FIG. 35 presents one such situation.

To most engineers, the intention of the user is clear from the drawing in FIG. 35. A FIR notch filter is desired. The problem is that there are many ambiguities in the drawing. Even when all elements of the diagram are correctly recognized, the units of the 100 mark in the axis is not clear, the y-axis data scaling is left undefined, and the pass-band boundaries are also undefined. Moreover, even the exact locations of the passband and notch are unclear.

An intermediate graph representing FIG. 35 may incorporate such ambiguities as part of the representation. Some ambiguities are incorporated into node information and others into edge and sub-graph groupings. FIG. 36 shows an example intermediate graph representation of the design problem. A set of rules based on common assumptions about filter design can be applied to this graph to reduce or further specify the graph. For example, the 100 mark can be assumed to be 100 Hz (given the sampling rate), and also the vertical bars can be assumed to be ⅓ of the sampling range apart.

An alternative is to maintain the ambiguity in the graph and query the user for parameters as necessary to resolve the ambiguities. Based on the user input for the remaining missing parameters, a complete set of filters to achieve the desired response (e.g., as shown in FIG. 36) can be designed. The user can then select a filter from this final set.

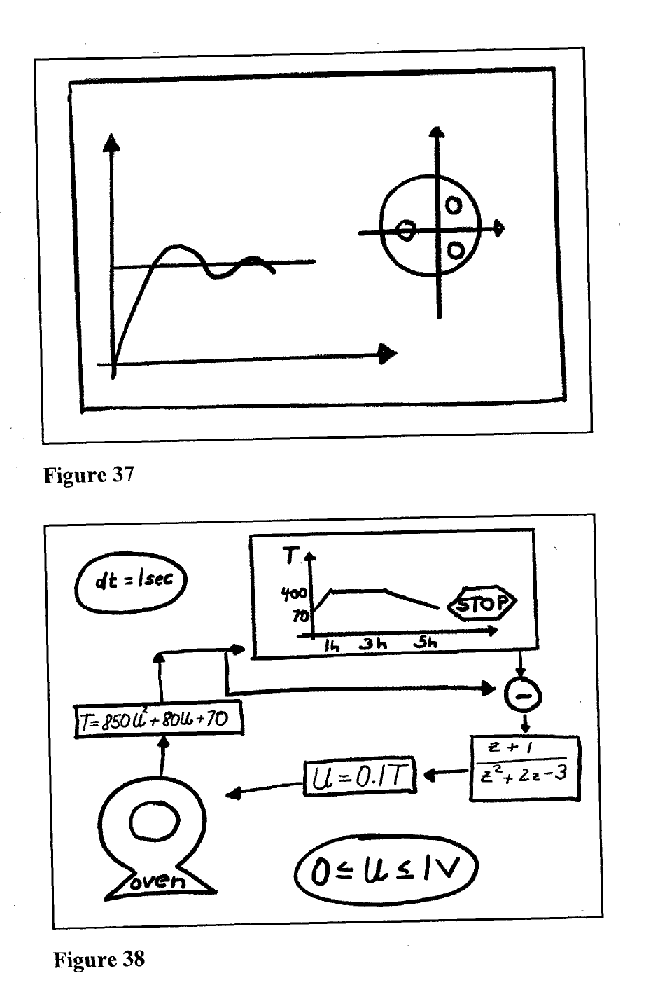

FIG. 37 shows a hand drawn control design where both step response and pole placement are specified. Control engineers specify characteristic properties of control systems with the aid of tools such as step response diagrams (left) and pole location diagrams (right). Using the present invention, the system receives the diagrams and identifies the shape and location of the desired step response. According to the invention, this information is encoded into a graph representation that is then preferably reduced and output into a representation readily understood by conventional computer-aided control design software.

The small circles (poles) in the right-hand diagram in FIG. 37 are interpreted as being part of the larger circle. The graph representing this diagram includes adjacencies having information such as “one small circle on the x-axis to the left of the y-axis.” This information in the graph can then be transformed and output for use by conventional computer-aided control design software. Moreover, an approximation of the actual location of the small circles (representing poles) in the pole location diagram can be encoded into the graph, fine-tuned as necessary (graphically or numerically), and output for use by the control design software.

Sketch-Based Real World Applications

FIG. 38 is an example sketch of a real-world measurement and control system. The principles of the invention discussed herein may be used to recognize such sketches and translate them into one or more internal graph representations that can be executed.

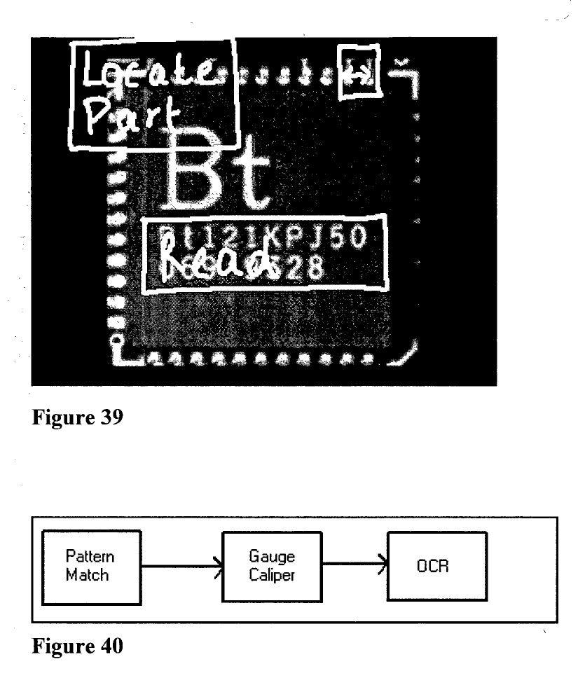

Ambiguous representations play an important part in real world applications. As explained earlier, disambiguation can be done by presenting the user with a set of options. For example in FIG. 38, the user may be queried whether “T” in all instances represents temperature or whether other parameters, such as time, are involved. Again, the intention is not to execute arbitrary diagrams, but create formal or semi-formal specifications that can be executed. For example, an external database containing symbols may provide information that depends on the domain of the symbol (for the “oven” in the FIG. 39, T may be temperature). Some symbols may be determined not important at all to the final outcome.

Sketch-Based Machine Vision

Hand drawn diagrams can be used very effectively to set up inspection tasks in machine vision applications. Machine vision applications analyze and process images to inspect objects or parts within an image.

A machine vision application may use one or more images obtained from a camera or equivalent optical device. The image or images to be analyzed may alternatively be obtained from a file stored on a computer-readable medium, such as an optical or magnetic disk or memory chip. The image may be presented to the user who graphically specifies the machine vision tasks (e.g., using a pen or mouse) on top of or to the side of the image. The user may also specify the machine vision instructions prior to receiving the image for analysis.

In either case, the user may use predefined names for regions of the image when specifying the portions of the image to be analyzed. The process for recognizing the graphically-specified instructions is as described above. The symbols in the instructions are first identified and boxes constituting nodes in a graph are constructed around some or all of the identified symbols. The relationship between the symbols may be inferred from the spatial relationship between the boxes. A graphically-specified instruction may then be identified by comparing the pattern of the graph with previously generated graph patterns representing known instructions. The identified instructions are preferably output from the recognition process in a computer-readable form that is understood and possibly executed by a program component in the computer.

A set of common machine vision tasks exists for most machine vision applications. These tasks include locating the part to be inspected (location), identifying the type of object or part being inspected (identification), making dimensional measurements on the part (gauging) and inspecting the part for defects (inspection). Some common tools used for these tasks are pattern matching, edge detection, optical character recognition, and intensity measurements. Also, in most applications, these tasks are performed in a particular and well-defined order.

FIG. 39 shows how one can use hand drawn sketches to set up a machine vision inspection application on a sample image that represents images to be acquired during the inspection. Each task is specified using a keyword and the area of the image in which that task is performed is specified by a region. The keywords, for example, could be common names associated with the task (such as locate, read, measure, pattern match, gauge, OCR, etc.). The recognition process of the present invention first recognizes the keywords (tasks) and the regions associated with each keyword. The user preferably has the option of allowing the process to determine the order in which the tasks are performed or asking the process to perform the tasks in the order they were drawn on the image. This may result in a diagram or a flowchart (FIG. 40) with blocks that contain machine vision operations. The resulting diagram or flowchart can be easily mapped to commercially-available machine vision software and/or hardware. For more complicated applications, the recognition process could result in directed graphs that are mapped to machine vision software/hardware.

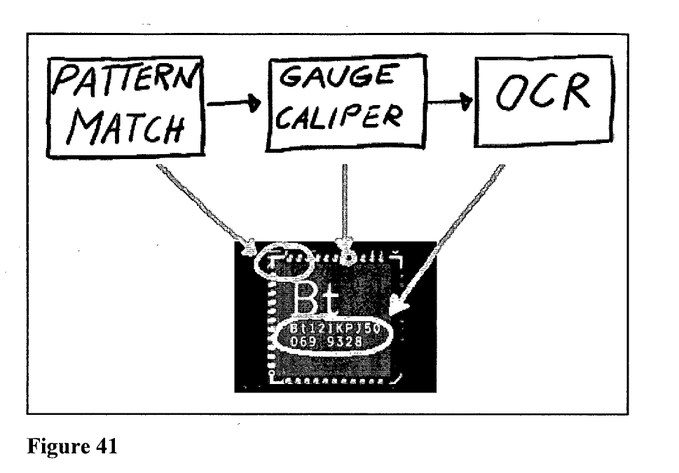

Alternatively, the user could first draw the block diagram (FIG. 41) and then select each block to further specify the recognized tasks. Blocks can be set up by assigning images or portions of an image with a line drawn from the hand drawn instructions to each block as shown in FIG. 41.

The invention presented herein considerably simplifies the specification of machine vision inspection tasks and allows users to take full advantage of a pen or mouse centric computer to set up the application. If the machine vision instructions specify characteristics to be found in the image under analysis and those characteristics are not found in the image (for example, the physical dimension of an object in the image does not meet specified tolerances), the absence of the specified characteristics may be reported to the user.

### REFERENCES

The following references have been cited above or are otherwise instructive of the state of the art, and are incorporated by reference herein:

Ablameyko, S., Pridmore, T., Machine Interpretation of Line Drawing Images, Springer-Verlag London, 2000.

Anderson, R., Two-dimensional mathematical notation, In Syntactic Pattern Recognition, Applications, ed. K. S. Fu, 147-177, Springer, 1977.

Alvarado, C., Oltmans, M., Davis, R., A framework for multi-domain sketch recognition, AAAI Spring Symposium, Sketch Understanding, 2002.

Atallah, M. J., Algorithms and Theory of Computation Handbook, CRC Press, Chapter 6.7, 1999.

Bimber O., Encarnacao, L. M., Stork, A., A multi-layered architecture for sketch-based interaction within virtual environments, Computers and Graphics, vol. 24, 851-857, 2000.

Blostein, D., Grbavec, A., Recognition of mathematical notation, chapter 22. World Scientific Publishing Company, 1996.

Blostein, D., Grbavec, A., Recognition of mathematical notation, in H. Bunke and P. Wang (eds.), Handbook of Character Recognition and Document Image Analysis, 557-582, World Scientific Publishing, Singapore, 1997.

Calhoun, C., Stahovich, T. F., Kurtoglu, T., Kara, L. B., Recognizing multi-stroke symbols, AAAI Spring Symposium, Sketch Understanding, 2002.

Chan, K.-F., Yeung, D.-Y., Mathematical expression recognition, Technical Report HKUST-CS99-04, 1999.

Chang, S., A method for the structural analysis of two-dimensional mathematical expressions, Information Sciences 2, 3, 253-272, 1970.

Chou, P. A., Recognition of equations using a two-dimensional stochastic contextfree grammar, Proceedings SPIE Visual Communications and Image Processing IV, 1192:852-863, November 1989.

Damm, C. H., Hansen, K. M., Thomsen, M., Tool support for cooperative objectoriented design: gesture based modeling on an electronic whiteboard, In Proceedings of CHI2000, 2000.

Dillner, H., Schnelles Simulink-Prototyping mit preiswerter Hardware, Elektronik, Germany, 22/99, 82-87, 1999.

Dillner, H., Zum Standard geworden: Graphische Programmierung, Elektronik, Germany, 02/99, 74-79, 1999.

Egenhofer, M., Query processing in spatial-query-by-sketch, Journal of Visual Languages and Computing, 8(4), 403-424, 1997.

Ehrig, H., Handbook of Graph Grammars and Computing by Graph Transformation, vol. 1, World Scientific Publishing, 1997.

Ehrig, H., Engels, G., Kreowski, H.-J., Rozenberg, G., Handbook of Graph Grammars and Computing by Graph Transformation, vol. 2, World Scientific Publishing, 1999.

Ferguson, R. W., Forbus, K. D., A cognitive approach to sketch understanding, AAAI Spring Symposium, Sketch Understanding, 2002.

Forbus, K. D., Ferguson, R. W., Usher, J. M., Towards a computational model of sketching, Proceedings of the International Conference on Intelligent User Interfaces, Santa Fe, 2000.

Gross, M., Do, E., Drawing analogies—Supporting creative architectural design with visual references, 3^{rd} International Conference on Computational Models of Creative Design, M.-L. Maher and J. Gero (eds.), Sydney, 37-58, 1995.

Hammond, T., Davis, R., Tahuti: A geometrical sketch recognition system for UML class diagrams, AAAI Spring Symposium, Sketch Understanding, 2002.

Kurtoglu, T., Stahovich, T. F., Interpreting schematic sketches using physical reasoning, AAAI Spring Symposium, Sketch Understanding, 2002.

Landay, J. A., Mayers, B. A., Interactive sketching for the early stages of user interface design, CHI, 43-50, 1995.

Lank, E., Thorley, J. S., Chen, S. J.-S., An interactive system for recognizing hand drawn UML diagrams, In Proceedings for CASCON, 2000.

Lecolinet, E., Designing GUIs by sketch drawing and visual programming, Proceedings of the International Conference on Advanced Visual Interfaces, AVI, 274-276, 1998.

Lin, J., Newman, M. W., Hong, J. I., Landay, J. A., Denim: An informal tool for early stage web site design, CHI, 205-206, 2001.

Matsakis, N., Recognition of handwritten mathematical expressions, Master's Report, MIT, 1999.

Miller, E. G., Viola, P. A., Ambiguity and constraints in mathematical expression recognition, Proceedings of AAAI-98, 1998.

Okamura, H., Kanahori, T., Suzuki, M., Fukuda, R., Cong, W., Tamari, F. Handwriting interface for computer algebra, Proceedings of the Fourth Asian Technology Conference in Mathematics, 1999.

Shilman, M., Pasula, H., Russell, S., Newton, R., Statistical visual language models for ink parsing, AAAI Spring Symposium, Sketch Understanding, 2002.

Skubic, M., Blisard, S., Carle, A., Matsakis, P., Hand drawn maps for robot navigation, AAAI Spring Symposium, Sketch Understanding, 2002.

Smithies, S., Novins, K., Arvo, J., A handwriting-based equation editor, In Proceedings of Graphics Interface '99, 1999.

Tombre, K., Structural and syntactic methods in line drawing analysis: To which extent do they work?, Proceedings of the Workshop on Structural and Syntactical Pattern Recognition, 1996.

Ullmann, J. R., An algorithm for sub-graph isomorphism, Journal of the ACM 23(1):31-42, 1976.

Wang, Z., Faure, C., Structural analysis of handwritten mathematical expressions, Proc. 9^{th} Int. Conf. on Pattern Recognition, 32-34, 1988.

Zanibbi, R., Recognition of mathematics notation via computer using baseline structure, External Technical Report Queens University, Canada, ISSN-0836-0227-2000-439, 2000.

Zanibbi, R., Blostein, D., Cordy, J. R., Baseline structure analysis of handwritten mathematics notation, Proc. Sixth Intl. Conf. on Document Analysis and Recognition, Seattle, Wash., IEEE Computer Society Press, pp. 768-773, 2001.

United States patents discussed in this document are also instructive of the state of the art and are incorporated by reference herein.

While various preferred embodiments of the invention have been illustrated and described above, it will be appreciated that various changes can be made without departing from the spirit and scope of the invention. The scope of the invention should therefore be determined from the following claims and equivalents thereto.

The embodiments of the invention in which an exclusive property or privilege is claimed are defined as follows:

1. A method for use in recognizing a graphical or diagrammatic representation in a computer, the method comprising:
(a) identifying one or more symbols in the graphical or diagrammatic representation;
(b) identifying one or more relationships between the identified symbols;
(c) generating an adjacency matrix in the computer, said adjacency matrix corresponding to a graph having one or more nodes in an arrangement that represents information obtained from the identified symbols and their relationship to each other; and
(d) applying one or more rules to the adjacency matrix to modify the graph toward a desired arrangement.

2. The method of claim 1, in which the graph is an initial graph and the desired arrangement is a reduced graph having fewer nodes or edges than the initial graph, and in which the reduced graph still represents information obtained from the identified symbols and their relationship to each other.

3. The method of claim 2, in which the reduced graph has one or more nodes in an arrangement that can be executed by a program component in the computer.

4. The method of claim 2, in which the reduced graph has one or more nodes in an arrangement that can produce computer-readable output representing the information obtained from the identified symbols and their relationship to each other.

5. The method of claim 4, in which the computer-readable output is executable by a program component in the computer.

6. The method of claim 1, further comprising identifying an ambiguity in the information obtained from the identified symbols and their relationship to each other, and representing the ambiguity in the graph in the form of one or more additional nodes or edges.

7. The method of claim 6, in which the desired arrangement is a modified graph in which the ambiguity is resolved.

8. The method of claim 7, in which the step of applying one or more rules to the adjacency matrix results in prompting a user to input information that resolves the ambiguity.

9. The method of claim 7, further comprising storing information relating to the resolution of a prior ambiguity, in which the step of applying one or more rules to the adjacency matrix uses said stored information to resolve the current ambiguity.

10. The method of claim 1, in which the step of applying one or more rules to the adjacency matrix is repeated until a specified condition is met.

11. The method of claim 1, further comprising applying a minimum spanning tree algorithm to the adjacency matrix to produce a minimum spanning tree representation of the graph.

12. The method of claim 1, in which the graph represents information obtained from only a portion of the identified symbols and their relationship to each other.

13. The method of claim 1, in which the step of identifying one or more symbols in the graphical or diagrammatic representation is limited to a portion of the graphical or diagrammatic representation.

14. The method of claim 1, in which one or more of the method steps are performed while the graphical or diagrammatic representation is being input into the computer.

15. The method of claim 1, in which the method steps are performed only after the graphical or diagrammatic representation has been input into the computer.

16. The method of claim 1, in which the graphical or diagrammatic representation is input into the computer in the form of handwritten text or hand drawing.

17. The method of claim 1, in which the graphical or diagrammatic representation is input into the computer in the form of an image of machine printed text or drawing.

18. The method of claim 1, in which one or more of the method steps are nested such that the method is performed on a portion of the graphical or diagrammatic representation contained within another portion of the graphical or diagrammatic representation.

19. The method of claim 1, further comprising specifying a hierarchy in the computer that determines the order in which the one or more rules are applied to the adjacency matrix.

20. The method of claim 1, in which the step of applying one or more rules to the adjacency matrix results in prompting a user to input additional information that is then represented in the graph.

21. The method of claim 1, in which the step of applying one or more rules to the adjacency matrix results in prompting a user to input information that corrects a mistake in the graph.

22. The method of claim 1, in which the one or more rules being applied to the adjacency matrix are selected for application based on an objective of the recognition process being performed.

23. The method of claim 22, in which the graphical or diagrammatic representation is a simulation and the objective of the recognition process is to produce simulation results, the one or more rules being selected for their capacity to modify the graph toward a desired arrangement in which the graph can be executed by a program component to produce the simulation results.

24. The method of claim 1, in which the desired arrangement is a canonical tree representation that can be used in a classifying, indexing, or searching operation based on the graphical or diagrammatic representation.

25. The method of claim 1, in which the one or more rules have a left side and a right side, the left side specifying a condition and the right side specifying an action to be taken when the left side condition is met.

26. The method of claim 25, in which the left side of a rule is a graph pattern, and the right side of the rule is a substitute graph pattern for replacing the left side graph pattern when the left side graph pattern is found in the graph.

27. The method of claim 25, in which the condition on the left side of a rule is specified using first order or higher order logic.

28. The method of claim 1, in which the step of applying one or more rules results in obtaining input from an external database that provides additional information to be represented in the graph.

29. The method of claim 1, in which the step of applying one or more rules results in adding one or more rules to be applied to the graph.

30. The method of claim 1, in which the step of applying one or more rules results in removing one or more rules from being applied to the graph.

31. The method of claim 1, in which the step of applying one or more rules results in modifying a rule to be applied to the graph.

32. The method of claim 1, further comprising constructing a box around one or more of the identified symbols and using the box in generating the adjacency matrix in the computer.

33. The method of claim 1, in which the graphical or diagrammatic representation includes a symbol that is input in a form simplified from a standard form of the symbol.

34. The method of claim 33, in which the simplified symbol is a partially-drawn version of the standard form of the symbol.

35. The method of claim 1, further comprising the step of identifying color information of one or more symbols in the graphical or diagrammatic representation, in which the color information is further represented in the graph.

36. The method of claim 35, in which the color information provides information concerning a relationship between symbols identified in the graphical or diagrammatic representation.

37. The method of claim 1, in which a containing symbol is identified in the graphical or diagrammatic representation, the method further comprising the step of generating a separate adjacency matrix corresponding to a separate graph having one or more nodes in an arrangement that represents information obtained from one or more symbols identified within the containing symbol.

38. The method of claim 37, in which the separate graph is incorporated into the graph that includes the containing symbol.

39. A method for automated recognition of a formula input graphically in a computer, comprising:
(a) for each symbol in the formula:
(i) grouping one or more strokes together that represent the symbol;
(ii) identifying the symbol;
(iii) constructing a box around the identified symbol; and
(iv) identifying a relationship between the symbol and another symbol in the formula;
(b) generating an adjacency matrix that describes the symbols and relationships between the symbols; and
(c) simplifying the adjacency matrix by applying one or more rules to the adjacency matrix.

40. The method of claim 39, in which for each symbol in the formula, the box replaces the symbol and constitutes a node in the graph corresponding to the adjacency matrix.

41. The method of claim 40, in which a relationship between symbols is identified by identifying a spatial relationship between the boxes constructed around each of the symbols.

42. The method of claim 41, in which a nested relationship between symbols is specified when the box around one symbol surrounds the box of another symbol.

43. The method of claim 39, in which the formula includes at least one meta-symbol that incorporates one or more symbols forming a portion of the formula.

44. The method of claim 43, in which the meta-symbol is a mathematical operand that includes one or more expressions in the mathematical operation specified by the meta-symbol.

45. The method of claim 39, in which the adjacency matrix corresponds with a graph having one or more nodes and edges, the method further comprising assigning weights to the edges for directing the preparation of a minimum spanning tree representation of the formula.

46. The method of claim 45, in which the weight assigned to an edge between nodes in the graph depends on the distance between the underlying symbols in the graphically-input formula.

47. The method of claim 45, in which the lower the weight assigned to an edge, the more likely the edge will be included in the minimum spanning tree representation.

48. The method of claim 39, in which the simplified adjacency matrix can produce a computer-readable expression that specifies the formula in a manner that can be understood by a program component in the computer.

49. The method of claim 39, in which the simplified adjacency matrix can produce a computer-readable expression that specifies the formula in a manner that can be executed by a program component in the computer.

50. A method for image analysis, comprising:
(a) receiving an image to be analyzed;
(b) receiving graphically-specified instructions that direct the analysis of the image, in which the instructions specify one or more regions of the image for the analysis;
(c) for the graphically-specified instructions:
(i) identifying the symbols that specify the instructions;
(ii) identifying relationships between the symbols;
(iii) identifying the instructions from the symbols and their relationships to each other; and
(iv) identifying the specified regions of the image associated with each of the instructions;
(d) executing the instructions on the specified regions of the image.

51. The method of claim 50, in which the instructions are graphically specified on top of the image to be analyzed.

52. The method of claim 50, in which the image is first displayed and a user inputs the instructions using a graphical input device.

53. The method of claim 52, in which the graphical input device is a pen configured to provide computer-readable input.

54. The method of claim 52, in which the graphical input device is a computer mouse.

55. The method of claim 50, in which the instructions are specified prior to receiving the image for analysis.

56. The method of claim 50, in which the instructions are standard names of operations associated with a program component that is being used to analyze the image.

57. The method of claim 50, in which the region of the image associated with an instruction is identified by a predefined name for the region.

58. The method of claim 50, in which the image depicts a physical object and the graphically-specified instructions direct measurements and interpretations to be performed on the object in the image.

59. The method of claim 50, in which the instructions are specified in the form of a flow chart that depicts the steps of analysis to be performed.

60. The method of claim 50 in which a region of the image is specified by a box drawn on the image around the region.

61. The method of claim 60, in which a graphically-specified instruction is associated with a region of the image by drawing a line between the instruction and the box specifying the region.

62. The method of claim 50, in which the image to be analyzed is received from a camera or equivalent optical device.

63. The method of claim 50, in which the image to be analyzed is received from a file stored on a computer-readable medium.

64. The method of claim 50, further comprising constructing boxes around each of the identified symbols, the boxes constituting nodes in a graph that represents the information presented by the symbols.

65. The method of claim 64, in which a relationship between symbols is identified by identifying a spatial relationship between the boxes constructed around each of the symbols.

66. The method of claim 65, in which a graphically-specified instruction is identified by comparing a pattern in the graph to previously-generated graph patterns representing known instructions.

67. The method of claim 50, in which the identified instructions are output in a computer-readable form that is understood by a program component being used to analyze the image.

68. The method of claim 50, in which the identified instructions are output in a computer-readable form that is executed by a program component being used to analyze the image.

69. The method of claim 50, in which the instructions specify characteristics to be found in the image, and if the analysis of the image does not identify said characteristics, the method further comprises the step of reporting the absence of said characteristics in the image.

70. A method for diagram recognition in a computer, comprising:
(a) receiving a graphically-specified diagram into the computer;
(b) analyzing the graphically-specified diagram and generating a graph having one or more nodes in an arrangement that represents the diagram by:
(i) identifying one or more symbols in the diagram;
(ii) constructing a box around one or more of the identified symbols and designating the box as a node in the graph; and
(iii) identifying a relationship between two or more of the identified symbols enclosed in boxes and using the relationship to specify an edge connecting the nodes that represent the boxes in the graph; and
(c) storing the graph in the computer in the form of an adjacency matrix.

71. The method of claim 70, further comprising applying one or more rules to the graph to modify the graph to a reduced form having fewer nodes or edges.

72. The method of claim 70, in which the relationship between identified symbols is specified by the spatial location of the symbols in the graphically-specified diagram.

73. The method of claim 70, in which the step of analyzing the diagram and generating the graph is performed while the diagram is being received into the computer.

74. The method of claim 70, in which the step of analyzing the diagram and generating the graph is performed after the diagram is received into the computer.

75. The method of claim 70, in which the graphically-specified diagram includes a feature that is handwritten or hand drawn.

76. The method of claim 70, in which the graphically-specified diagram includes an image of machine printed text or drawing.

77. The method of claim 76, in which the image is annotated with handwritten text or hand drawing.

78. The method of claim 70, in which the graphically-specified diagram depicts a visual program and the identified symbols represent programming constructs or program input or output of the visual program.

79. The method of claim 78, in which the graph is arranged such that it can be executed to perform the visual program.

80. The method of claim 78, further comprising generating textual program codes from the graph which can be executed in the computer.

81. The method of claim 70, in which the graphically-specified diagram depicts a simulation to be performed in the computer.

82. The method of claim 81, in which the graphically-specified diagram is a Simulink diagram.

83. The method of claim 81, in which the graph is a directed graph that represents the flow of data in the graphically-specified diagram.

84. The method of claim 70, in which the graphically-specified diagram is a graphical program having a front panel component and a corresponding output component.

85. The method of claim 84, in which the graphically-specified diagram is a LabVIEW diagram.

86. The method of claim 70, in which the graphically-specified diagram is a graphical program that includes both data flow and control flow elements.

87. The method of claim 86, in which the data flow elements are oriented horizontally and the control flow elements are oriented vertically in the graphically-specified diagram.

88. The method of claim 86, in which the graphically-specified diagram is an Agilent-VEE diagram.

89. The method of claim 70, in which the graphically-specified diagram is a flow chart.

90. The method of claim 89, further comprising the step of translating the graph representing the flow chart into a computer-readable format.

91. The method of claim 70, in which the graphically-specified diagram is a stateflow diagram.

92. The method of claim 91, in which the graph is a directed graph that represents states and transitions between states in the stateflow diagram.

93. The method of claim 70, further comprising the step of applying one or more rules to the graph to simplify the graph and produce a canonical representation of the graphically-specified diagram.

94. The method of claim 93, in which the canonical representation is added to a database of canonical representations and used as an index for a searching operation.

95. The method of claim 94, in which the searching operation includes the step of comparing a canonical representation of a diagram with canonical representations in the database to determine a matching canonical representation is present in the database.

96. The method of claim 70, in which the graphically-specified diagram specifies a digital filter and in which the graph representing the filter is capable of producing computer-readable output that implements the digital filter when the output is processed in a computer,

97. The method of claim 70, in which the graphically-specified diagram specifies a control design comprised of a step response and pole placement of the control design.

98. The method of claim 70, in which the graphically-specified diagram specifies tasks to be performed in the operation of a system comprised of physical equipment.

99. The method of claim 98, in which the physical equipment is to perform an inspection or measurement of a physical object.

100. The method of claim 70, in which the graphically-specified diagram is comprised of multiple diagrammatic portions, and the method steps for diagram recognition are separately performed on one or more of the multiple diagrammatic portions.
